(19) United States
(12) Patent Application Publication
(10) Pub. No.: US 2026/0204011 A1
(43) Pub. Date: Jul. 16, 2026

(54) EFFICIENT DYNAMIC GUARDIAN FOR EXTENDED REALITY

(71) Applicant: QUALCOMM Incorporated, San Diego, CA (US)

(72) Inventors: Alin-Eugen DONDERA, Amsterdam (NL); Mohsen GHAFOORIAN, Diemen (NL); Georgi DIKOV, Amsterdam (NL); Maksym RAITAROVSKYI, Madrid (ES); Gerhard REITMAYR, Del Mar, CA (US)

(21) Appl. No.: 19/025,823

(22) Filed: Jan. 16, 2025

(51) Int. Cl. G06T 17/00; G06T 7/12; G06V 10/25; G06V 10/82

(52) U.S. Cl. CPC G06T 17/00; G06T 7/12; G06V 10/25; G06V 10/82

(57) ABSTRACT

Systems and techniques are described for extended reality (XR). For example, a computing device (e.g., an XR device or a computing component of the XR device) can determine, using a first neural network based on a plurality of first images of a scene, whether a movable object is near an area of the scene (the area including an XR device worn by a user). The computing device can determine, using a second neural network in response to the first neural network determining the movable object is near the area, whether the movable object is within the area based on a plurality of second images of the scene. The computing device can display, on a display of the XR device to the user in response to the second neural network determining the movable object is within the area, a visual indication of the movable object within the area of the scene.

### FIELD

The present disclosure generally relates to extended reality. For example, aspects of the present disclosure relate to system designs and methods for an efficient dynamic guardian for extended reality, such as virtual reality.

### BACKGROUND

An extended reality (XR) (e.g., including virtual reality, augmented reality, and/or mixed reality) system can provide a user with a virtual experience by immersing the user in a completely virtual environment (made up of virtual content) and/or can provide the user with an augmented or mixed reality experience by combining a real-world or physical environment with a virtual environment.

One example use case for XR content that provides virtual, augmented, or mixed reality to users is to present a user with a “metaverse” experience. The metaverse is essentially a virtual universe that includes one or more three-dimensional (3D) virtual worlds. For example, a metaverse virtual environment may allow a user to virtually interact with other users (e.g., in a social setting, in a virtual meeting, etc.), to virtually shop for goods, services, property, or other item, to play computer games, and/or to experience other services.

XR headset users can be at risk of injury or material damage due to an impaired view of their physical surroundings, which can lead to potential collisions with people, pets, or objects.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for extended reality (XR). In some aspects, an apparatus for XR is provided. The apparatus includes at least one memory and at least one processor coupled to the at least one memory and configured to: determine, using a first neural network based on a plurality of first images of a scene, whether a movable object is near an area of the scene, wherein the area includes an XR device worn by a user; determine, using a second neural network in response to the first neural network determining the movable object is near the area, whether the movable object is within the area based on a plurality of second images of the scene; and output, for display on a display of the XR device to the user in response to the second neural network determining the movable object is within the area, a visual indication of the movable object within the area of the scene.

In some aspects, a method for XR is provided. The method includes: determining, by a first neural network based on a plurality of first images of a scene, whether a movable object is near an area of the scene, wherein the area includes an XR device worn by a user; determining, by a second neural network in response to the first neural network determining the movable object is near the area, whether the movable object is within the area based on a plurality of second images of the scene; and displaying, on a display of the XR device to the user in response to the second neural network determining the movable object is within the area, a visual indication of the movable object within the area of the scene.

In some aspects, a non-transitory computer-readable medium having stored thereon instructions that, when executed by at least one processor, cause the at least one processor to: determine, using a first neural network based on a plurality of first images of a scene, whether a movable object is near an area of the scene, wherein the area includes an XR device worn by a user; determine, using a second neural network in response to the first neural network determining the movable object is near the area, whether the movable object is within the area based on a plurality of second images of the scene; and output, for display on a display of the XR device to the user in response to the second neural network determining the movable object is within the area, a visual indication of the movable object within the area of the scene.

In some aspects, an apparatus for XR is provided. The apparatus includes: means for determining, based on a plurality of first images of a scene, whether a movable object is near an area of the scene, wherein the area includes an XR device worn by a user; means for determining, in response to the first neural network determining the movable object is near the area, whether the movable object is within the area based on a plurality of second images of the scene; and means for displaying, in response to the second neural network determining the movable object is within the area, a visual indication of the movable object within the area of the scene.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of an extended reality (XR) system, in accordance with some aspects of the disclosure.

FIG. 2 is a diagram illustrating an example of a three-dimensional (3D) collaborative virtual environment, in accordance with some aspects of the disclosure.

FIG. 3 is an image with a virtual representation (an avatar) of a user, in accordance with some aspects of the disclosure.

FIG. 4 is a diagram illustrating another example of an XR system, in accordance with some aspects of the disclosure.

FIG. 5 is a diagram illustrating an example configuration of a client device, in accordance with some aspects of the disclosure.

FIG. 6 is a diagram illustrating an example of a normal map, an albedo map, and a specular reflection map, in accordance with some aspects of the disclosure.

FIG. 7 is a diagram illustrating an example of a scene with a guardian area associated with a user wearing an XR device, in accordance with some aspects of the disclosure.

FIG. 8 is a flow diagram illustrating an example of a process for an efficient dynamic guardian system for identifying movable objects (e.g., intruders) within a guardian area of a user, in accordance with some aspects of the disclosure.

FIG. 9 is a diagram illustrating an example of a process for a classification network to identify a movable objects located near a guardian area of a user, in accordance with some aspects of the disclosure.

FIG. 10 is a diagram illustrating an example of a process for an instance segmentation and single depth network to identify a movable objects located within the guardian area of a user, in accordance with some aspects of the disclosure.

FIG. 11 is a diagram illustrating an example of a process for efficient 3D tracking of movable objects, in accordance with some aspects of the disclosure.

FIG. 12 is a diagram illustrating examples of segmentation masks of potential movable objects in a guardian area of a user, in accordance with some aspects of the disclosure.

FIG. 13 is a block diagram illustrating an example of a deep learning neural network, in accordance with some aspects of the disclosure.

FIG. 14 is a block diagram illustrating an example of a convolutional neural network, in accordance with some aspects of the disclosure.

FIG. 15 is a block diagram of an example transformer, in accordance with some aspects of the disclosure.

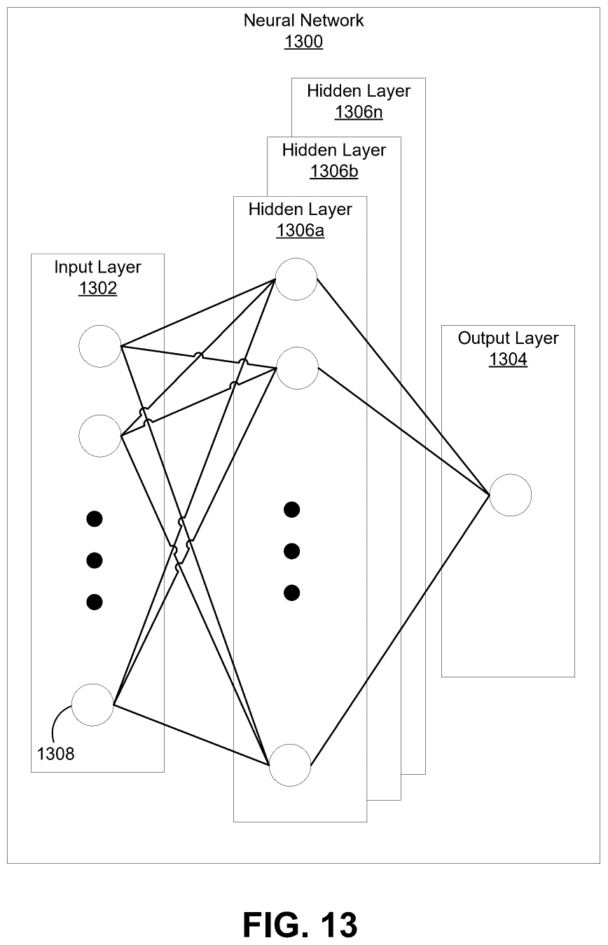

FIG. 13 is a flow diagram illustrating an example of a process for an efficient dynamic guardian for extended reality, such as virtual reality, in accordance with some aspects of the disclosure.

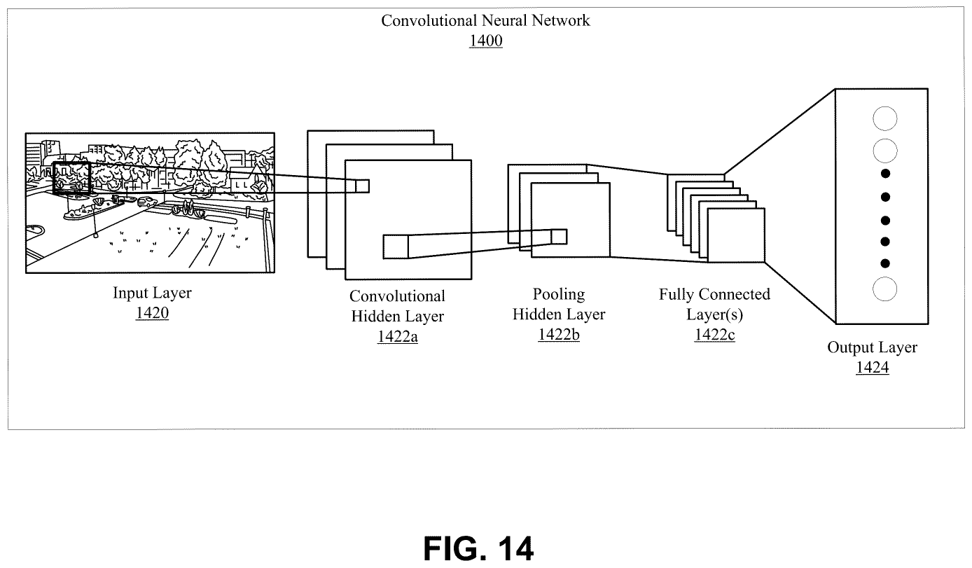

FIG. 14 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs), smart glasses (e.g., AR glasses, MR glasses, etc.), among others.

XR systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

As mentioned, XR headset users may be at risk of injury or material damage due to an impaired view of their physical surroundings, which can result in potential collisions with people, pets, or objects. It can be desirable for a system to be able to identify movable objects that cause collisions with the user, while balancing power efficiency and performance accuracy (e.g., accurately labeling challenges for detection of movable objects).

As such, improved systems and techniques for determining movable objects that may collide with a XR headset user, while balancing power efficiency and performance accuracy, can be beneficial.

In one or more aspects of the present disclosure, systems, apparatuses, methods (also referred to as processes), and computer-readable media (collectively referred to herein as “systems and techniques”) are described herein that provide solutions for an efficient dynamic guardian for extended reality, such as virtual reality.

Various aspects relate generally to extended reality. Some aspects more specifically relate to systems and techniques that provide solutions for an efficient and high-quality system for alerting users immersed in extended reality, such as virtual reality, whenever a movable object (e.g., a person, pet, or robotic device) enters into the user's safe space (e.g., a designated area surrounding the user, which may be referred to as a guardian area).

Power efficiency is an important factor for XR headsets and for the dynamic guardian systems and techniques described herein. For example, XR headsets have small form factors and thus the size (and thus capacity) of batteries for such devices is constrained. Using the dynamic guardian systems and techniques described herein, movable objects are continuously monitored relative to the designated area (e.g., the user's safe space). Such continuous identification of movable objects can be optimized for power consumption in order to ensure power efficiency. Any inefficiency in the systems and techniques can significantly degrade the user experience, such as by causing frequent battery drain and reducing the overall usability of the XR device.

According to various aspects, the systems and techniques described herein can ensure power efficiency, while maintaining sufficient accuracy of the alerts. In one or more examples, the systems and techniques provide for a two-stage hierarchical detection system for extended reality (e.g., virtual reality) environments that efficiently alerts users when a movable object intrude into the user's safe space (e.g., guardian area). The systems and techniques utilize minimal computations through a 3D data structure and neural network inferences at defined intervals, which can achieve a balance between power efficiency and alert accuracy while being cost-effective. For example, in a classification network stage, a classification network can determine whether a movable object (e.g., an intruder) is located near the user's guardian area. If the classification network determines a movable object (e.g., an intruder) is located near the user's guardian area, the system can switch to an instance segmentation and single depth estimation network stage, during which an instance segmentation and single depth estimation network can determine whether the intruder is in the user's guardian area. When the instance segmentation and single depth estimation network stage determines that the movable object is in the user's guardian area, the system can display (e.g., on a display of an XR headset worn by the user) to the user a visual indication of the movable object (e.g., a visual indication around the movable object in a virtual environment) within the user's guardian area (e.g., by using a video see through (VST) application). In some aspects, the system can switch back to the classification network stage if no movable objects have been detected by the instance segmentation and single depth estimation network stage for a given amount of time.

In some examples, the system includes multiple components, which include the classification network stage (e.g., a first neural network) and the instance segmentation and single depth estimation network stage (e.g., a second neural network). This two-stage hierarchical approach ensures that minimal computations are carried out when no movable object is detected as being near to the guardian area. The architectures of the segmentation network can be extended in an efficient manner to facilitate this use case. When an intruder is located in the guardian area, the 3D data structure employed by the systems and techniques described herein allows for neural network inferences to be executed at specific image frame intervals to benefit from minimal motion of the movable object (while also accounting for the user's headset motion) between the consecutive image frames. A data pseudo-labelling process is employed and enables large scale training of the two neural networks used in the system.

The systems and techniques strike a balance between the power efficiency, while not diminishing the user's guardian area experience of safeguarding the user from potential collisions with movable objects.

In one or more aspects, during operation of a method for extended reality, a first neural network can determine, based on a plurality of first images of a scene, whether a movable object is near an area of the scene, wherein the area includes an XR device worn by a user. A second neural network can determine, in response to the first neural network determining the movable object is near the area, whether the movable object is within the area based on a plurality of second images of the scene. A display of the XR device can display, to the user in response to the second neural network determining the movable object is within the area, a visual indication of the movable object (e.g., a visual indication around the movable object in a virtual environment) within the area of the scene. For example, a portion of an image where a movable object is detected can be extracted (e.g., cropped) and blended with virtual content of the virtual environment for display on the display of the XR device (e.g., by using a VST application).

In one or more examples, determining, by the first neural network, whether the movable object is near the area can be based on a distance between the movable object and the area being less than a threshold distance. In some examples, one or more tracking cameras can obtain the plurality of first images of the scene. In one or more examples, the plurality of first images of the scene can be grayscale images.

In some examples, determining, by the second neural network, whether the movable object is within the area can be further based on determining one or more segmentation masks for the plurality of second images, where a segmentation mask of the one or more segmentation masks can be associated with the movable object. In one or more examples, determining, by the second neural network, whether the movable object is within the area can be further based on determining a respective depth value for each segmentation mask of the one or more segmentation masks. In some examples, determining, by the second neural network, whether the movable object is within the area can be further based on determining a depth value of the respective depth values is not located within a predefined region surrounding the user. In one or more examples, one or more color image sensors can obtain the plurality of second images. In some examples, the plurality of second images can be red, green, blue (RGB) images.

In one or more examples, the XR device can be a head-mounted device. In some examples, the first neural network can process the plurality of first images at a first frame rate, the second neural network can process the plurality of second images at a second frame rate, and the first frame rate can be lower than the second frame rate. In some examples, the second neural network can process the plurality of second images at different intervals based on movable object motion. In one or more examples, each first image of the plurality of first images can have a lower resolution than each second image of the plurality of second images. In some examples, the movable object can be a person, animal, or robotic device. In one or more examples, the first neural network and the second neural network can be within the XR device.

Particular aspects of the subject matter described in this disclosure can be implemented to realize one or more of the following potential advantages. In one or more examples, the systems and techniques can provide a benefit of identifying movable objects (e.g., intruders) that are located within an XR user's safe space (e.g., guardian area) that may collide with the user, while balancing power efficiency and identification accuracy.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

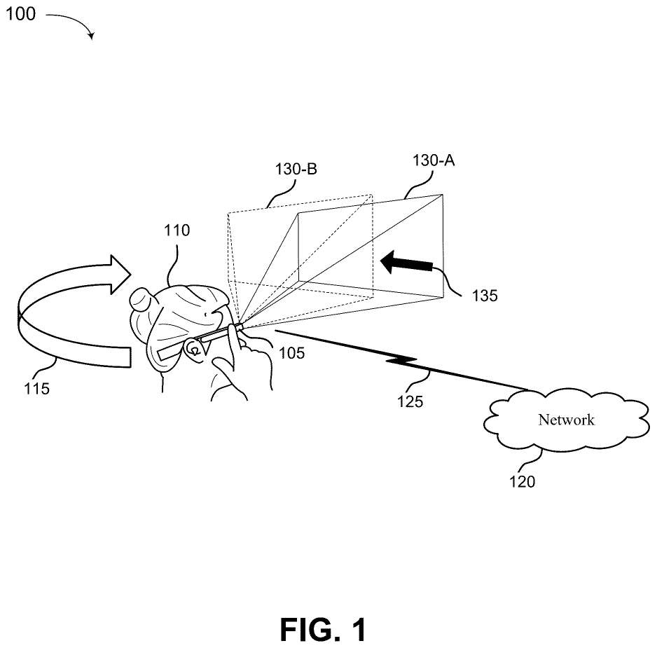

FIG. 1 illustrates an example of an extended reality system 100. As shown, the extended reality system 100 includes a device 105, a network 120, and a communication link 125. In some cases, the device 105 may be an extended reality (XR) device, which may generally implement aspects of extended reality, including virtual reality (VR), augmented reality (AR), mixed reality (MR), etc. Systems including a device 105, a network 120, or other elements in extended reality system 100 may be referred to as extended reality systems.

The device 105 may overlay virtual objects with real-world objects in a view 130. For example, the view 130 may generally refer to visual input to a user 110 via the device 105, a display generated by the device 105, a configuration of virtual objects generated by the device 105, etc. For example, view 130-A may refer to visible real-world objects (also referred to as physical objects) and visible virtual objects, overlaid on or coexisting with the real-world objects, at some initial time. View 130-B may refer to visible real-world objects and visible virtual objects, overlaid on or coexisting with the real-world objects, at some later time. Positional differences in real-world objects (e.g., and thus overlaid virtual objects) may arise from view 130-A shifting to view 130-B at 135 due to head motion 115. In another example, view 130-A may refer to a completely virtual environment or scene at the initial time and view 130-B may refer to the virtual environment or scene at the later time.

Generally, device 105 may generate, display, project, etc. virtual objects and/or a virtual environment to be viewed by a user 110 (e.g., where virtual objects and/or a portion of the virtual environment may be displayed based on user 110 head pose prediction in accordance with the techniques described herein). In some examples, the device 105 may include a transparent surface (e.g., optical glass) such that virtual objects may be displayed on the transparent surface to overlay virtual objects on real word objects viewed through the transparent surface. Additionally or alternatively, the device 105 may project virtual objects onto the real-world environment. In some cases, the device 105 may include a camera and may display both real-world objects (e.g., as frames or images captured by the camera) and virtual objects overlaid on displayed real-world objects. In various examples, device 105 may include aspects of a virtual reality headset, smart glasses, a live feed video camera, a GPU, one or more sensors (e.g., such as one or more IMUs, image sensors, microphones, etc.), one or more output devices (e.g., such as speakers, display, smart glass, etc.), etc.

In some cases, head motion 115 may include user 110 head rotations, translational head movement, etc. The device 105 may update the view 130 of the user 110 according to the head motion 115. For example, the device 105 may display view 130-A for the user 110 before the head motion 115. In some cases, after the head motion 115, the device 105 may display view 130-B to the user 110. The extended reality system (e.g., device 105) may render or update the virtual objects and/or other portions of the virtual environment for display as the view 130-A shifts to view 130-B.

In some cases, the extended reality system 100 may provide various types of virtual experiences, such as a three-dimensional (3D) gaming experiences, social media experiences, collaborative virtual environment for a group of users (e.g., including the user 110), among others. While some examples provided herein apply to 3D collaborative virtual environments, the systems and techniques described herein apply to any type of virtual environment or experience in which a virtual representation (or avatar) can be used to represent a user or participant of the virtual environment/experience.

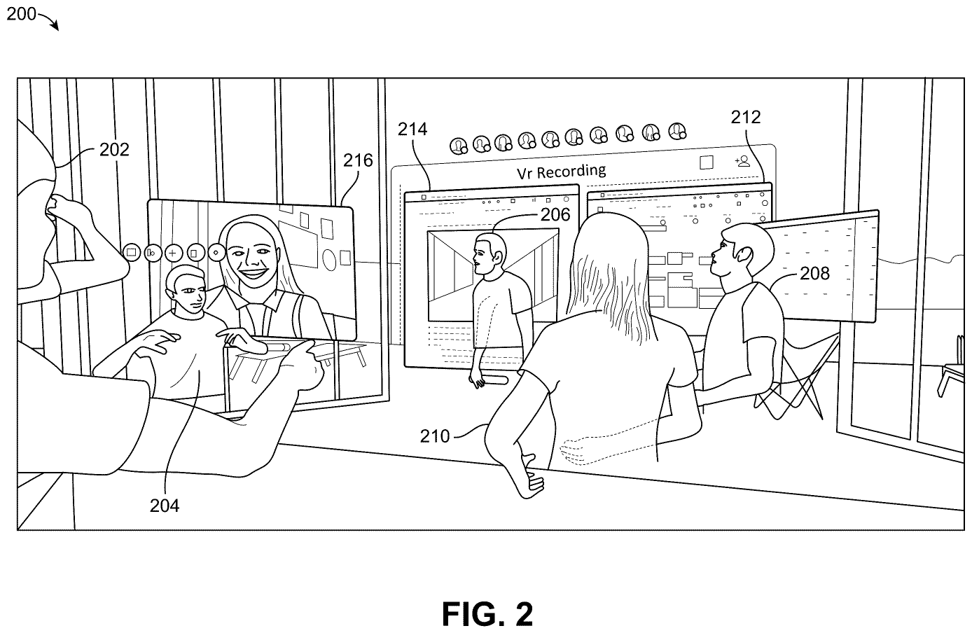

FIG. 2 is a diagram illustrating an example of a 3D collaborative virtual environment 200 in which various users interact with one another in a virtual session via virtual representations (or avatars) of the users in the virtual environment 200. The virtual representations include including a virtual representation 202 of a first user, a virtual representation 204 of a second user, a virtual representation 206 of a third user, a virtual representation 208 of a fourth user, and a virtual representation 210 of a fifth user. Other background information of the virtual environment 200 is also shown, including a virtual calendar 212, a virtual web page 214, and a virtual video conference interface 216. The users may visually, audibly, haptically, or otherwise experience the virtual environment from each user's perspective while interacting with the virtual representations of the other users. For example, the virtual environment 200 is shown from the perspective of the first user (represented by the virtual representation 202).

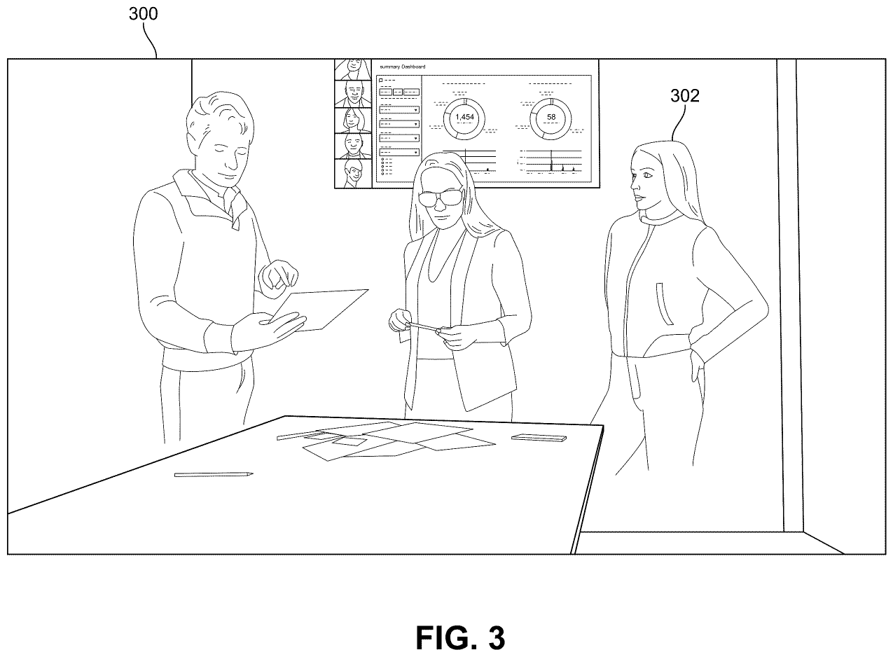

FIG. 3 is an image 300 illustrating an example of virtual representations of various users, including a virtual representation 302 of one of the users. For instance, the virtual representation 302 may be used in the 3D collaborative virtual environment 200 of FIG. 2.

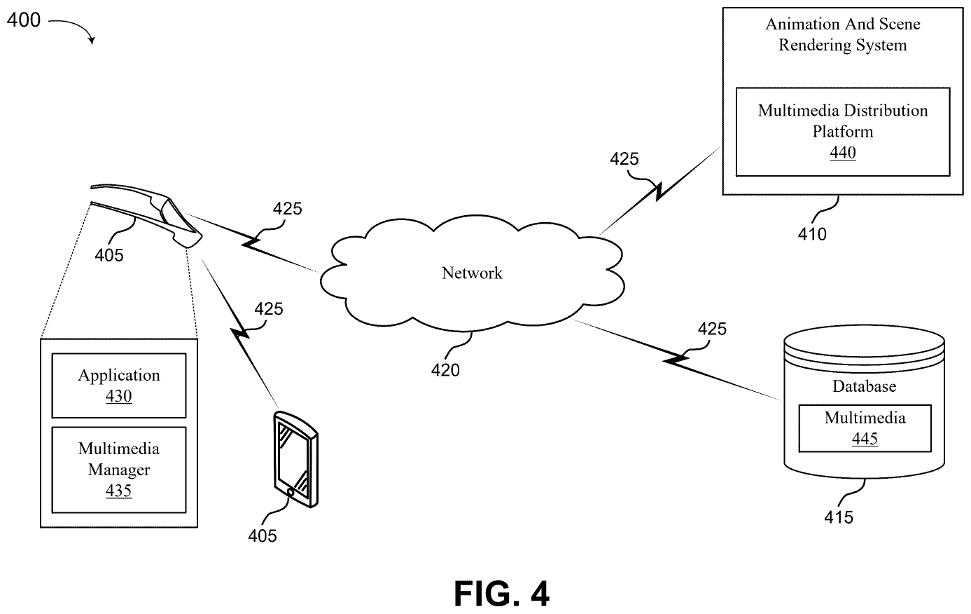

FIG. 4 is a diagram illustrating an example of a system 400 that can be used to perform the systems and techniques described herein, in accordance with aspects of the present disclosure. As shown, the system 400 includes client devices 405, an animation and scene rendering system 410, and storage 415. Although the system 400 illustrates two devices 405, a single animation and scene rendering system 410, a single storage 415, and a single network 420, the present disclosure applies to any system architecture having one or more devices 405, animation and scene rendering systems 410, storage 415, and networks 420. In some cases, the storage 415 may be part of the animation and scene rendering system 410. The devices 405, the animation and scene rendering system 410, and the storage 415 may communicate with each other and exchange information that supports generation of virtual content for XR, such as multimedia packets, multimedia data, multimedia control information, pose prediction parameters, via network 420 using communications links 425. In some cases, a portion of the techniques described herein for providing distributed generation of virtual content may be performed by one or more of the devices 405 and a portion of the techniques may be performed by the animation and scene rendering system 410, or both.

A device 405 may be an XR device (e.g., a head-mounted display (HMD), XR glasses such as virtual reality (VR) glasses, augmented reality (AR) glasses, etc.), a mobile device (e.g., a cellular phone, a smartphone, a personal digital assistant (PDA), etc.), a wireless communication device, a tablet computer, a laptop computer, and/or other device that supports various types of communication and functional features related to multimedia (e.g., transmitting, receiving, broadcasting, streaming, sinking, capturing, storing, and recording multimedia data). A device 405 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 405 may also be able to communicate directly with another device (e.g., using a peer-to-peer (P2P) or device-to-device (D2D) protocol, such as using sidelink communications). For example, a device 405 may be able to receive from or transmit to another device 405 variety of information, such as instructions or commands (e.g., multimedia-related information).

The devices 405 may include an application 430 and a multimedia manager 435. While the system 400 illustrates the devices 405 including both the application 430 and the multimedia manager 435, the application 430 and the multimedia manager 435 may be an optional feature for the devices 405. In some cases, the application 430 may be a multimedia-based application that can receive (e.g., download, stream, broadcast) from the animation and scene rendering systems 410, storage 415 or another device 405, or transmit (e.g., upload) multimedia data to the animation and scene rendering systems 410, the storage 415, or to another device 405 via using communications links 425.

The multimedia manager 435 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 435 may process multimedia (e.g., image data, video data, audio data) from and/or write multimedia data to a local memory of the device 405 or to the storage 415.

The multimedia manager 435 may also be configured to provide multimedia enhancements, multimedia restoration, multimedia analysis, multimedia compression, multimedia streaming, and multimedia synthesis, among other functionality. For example, the multimedia manager 435 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 435 may process multimedia data to support server-based pose prediction for XR, according to the techniques described herein.

The animation and scene rendering system 410 may be a server device, such as a data server, a cloud server, a server associated with a multimedia subscription provider, proxy server, web server, application server, communications server, home server, mobile server, edge or cloud-based server, a personal computer acting as a server device, a mobile device such as a mobile phone acting as a server device, an XR device acting as a server device, a network router, any combination thereof, or other server device. The animation and scene rendering system 410 may in some cases include a multimedia distribution platform 440. In some cases, the multimedia distribution platform 440 may be a separate device or system from the animation and scene rendering system 410. The multimedia distribution platform 440 may allow the devices 405 to discover, browse, share, and download multimedia via network 420 using communications links 425, and therefore provide a digital distribution of the multimedia from the multimedia distribution platform 440. As such, a digital distribution may be a form of delivering media content such as audio, video, images, without the use of physical media but over online delivery mediums, such as the Internet. For example, the devices 405 may upload or download multimedia-related applications for streaming, downloading, uploading, processing, enhancing, etc. multimedia (e.g., images, audio, video). The animation and scene rendering system 410 or the multimedia distribution platform 440 may also transmit to the devices 405 a variety of information, such as instructions or commands (e.g., multimedia-related information) to download multimedia-related applications on the device 405.

The storage 415 may store a variety of information, such as instructions or commands (e.g., multimedia-related information). For example, the storage 415 may store multimedia 445, information from devices 405 (e.g., pose information, representation information for virtual representations or avatars of users, such as codes or features related to facial representations, body representations, hand representations, etc., and/or other information). A device 405 and/or the animation and scene rendering system 410 may retrieve the stored data from the storage 415 and/or more send data to the storage 415 via the network 420 using communication links 425. In some examples, the storage 415 may be a memory device (e.g., read only memory (ROM), random access memory (RAM), cache memory, buffer memory, etc.), a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 420 may provide encryption, access authorization, tracking, Internet Protocol (IP) connectivity, and other access, computation, modification, and/or functions. Examples of network 420 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 420 may include the Internet.

The communications links 425 shown in the system 400 may include uplink transmissions from the device 405 to the animation and scene rendering systems 410 and the storage 415, and/or downlink transmissions, from the animation and scene rendering systems 410 and the storage 415 to the device 405. The communications links 425 may transmit bidirectional communications and/or unidirectional communications. In some examples, the communication links 425 may be a wired connection or a wireless connection, or both. For example, the communications links 425 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

In some aspects, a user of the device 405 (referred to as a first user) may be participating in a virtual session with one or more other users (including a second user of an additional device). In such examples, the animation and scene rendering systems 410 may process information received from the device 405 (e.g., received directly from the device 405, received from storage 415, etc.) to generate and/or animate a virtual representation (or avatar) for the first user. The animation and scene rendering systems 410 may compose a virtual scene that includes the virtual representation of the user and in some cases background virtual information from a perspective of the second user of the additional device. The animation and scene rendering systems 410 may transmit (e.g., via network 120) a frame of the virtual scene to the additional device. Further details regarding such aspects are provided below.

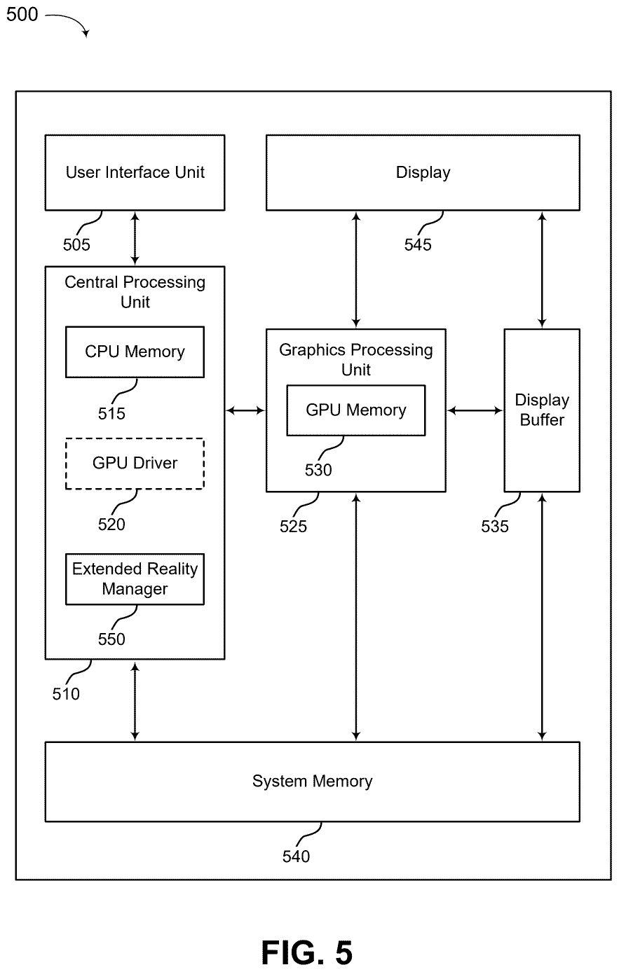

FIG. 5 is a diagram illustrating an example of a device 500. The device 500 can be implemented as a client device (e.g., device 405 of FIG. 4) or as an animation and scene rendering system (e.g., the animation and scene rendering system 410). As shown, the device 500 includes a central processing unit (CPU) 510 having CPU memory 515, a GPU 525 having GPU memory 530, a display 545, a display buffer 535 storing data associated with rendering, a user interface unit 505, and a system memory 540. For example, system memory 540 may store a GPU driver 520 (illustrated as being contained within CPU 510 as described below) having a compiler, a GPU program, a locally-compiled GPU program, and the like. User interface unit 505, CPU 510, GPU 525, system memory 540, display 545, and extended reality manager 550 may communicate with each other (e.g., using a system bus).

Examples of CPU 510 include, but are not limited to, a digital signal processor (DSP), general purpose microprocessor, application specific integrated circuit (ASIC), field programmable logic array (FPGA), or other equivalent integrated or discrete logic circuitry. Although CPU 510 and GPU 525 are illustrated as separate units in the example of FIG. 5, in some examples, CPU 510 and GPU 525 may be integrated into a single unit. CPU 510 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 545. As illustrated, CPU 510 may include CPU memory 515. For example, CPU memory 515 may represent on-chip storage or memory used in executing machine or object code. CPU memory 515 may include one or more volatile or non-volatile memories or storage devices, such as flash memory, a magnetic data media, an optical storage media, etc. CPU 510 may be able to read values from or write values to CPU memory 515 more quickly than reading values from or writing values to system memory 540, which may be accessed, e.g., over a system bus.

GPU 525 may represent one or more dedicated processors for performing graphical operations. For example, GPU 525 may be a dedicated hardware unit having fixed function and programmable components for rendering graphics and executing GPU applications. GPU 525 may also include a DSP, a general purpose microprocessor, an ASIC, an FPGA, or other equivalent integrated or discrete logic circuitry. GPU 525 may be built with a highly-parallel structure that provides more efficient processing of complex graphic-related operations than CPU 510. For example, GPU 525 may include a plurality of processing elements that are configured to operate on multiple vertices or pixels in a parallel manner. The highly parallel nature of GPU 525 may allow GPU 525 to generate graphic images (e.g., graphical user interfaces and two-dimensional or three-dimensional graphics scenes) for display 545 more quickly than CPU 510.

GPU 525 may, in some instances, be integrated into a motherboard of device 500. In other instances, GPU 525 may be present on a graphics card or other device or component that is installed in a port in the motherboard of device 500 or may be otherwise incorporated within a peripheral device configured to interoperate with device 500. As illustrated, GPU 525 may include GPU memory 530. For example, GPU memory 530 may represent on-chip storage or memory used in executing machine or object code. GPU memory 530 may include one or more volatile or non-volatile memories or storage devices, such as flash memory, a magnetic data media, an optical storage media, etc. GPU 525 may be able to read values from or write values to GPU memory 530 more quickly than reading values from or writing values to system memory 540, which may be accessed, e.g., over a system bus. That is, GPU 525 may read data from and write data to GPU memory 530 without using the system bus to access off-chip memory. This operation may allow GPU 525 to operate in a more efficient manner by reducing the need for GPU 525 to read and write data via the system bus, which may experience heavy bus traffic.

Display 545 represents a unit capable of displaying video, images, text or any other type of data for consumption by a viewer. In some cases, such as when the device 500 is implemented as an animation and scene rendering system, the device 500 may not include the display 545. The display 545 may include a liquid-crystal display (LCD), a light emitting diode (LED) display, an organic LED (OLED), an active-matrix OLED (AMOLED), or the like. Display buffer 535 represents a memory or storage device dedicated to storing data for presentation of imagery, such as computer-generated graphics, still images, video frames, or the like for display 545. Display buffer 535 may represent a two-dimensional buffer that includes a plurality of storage locations. The number of storage locations within display buffer 535 may, in some cases, generally correspond to the number of pixels to be displayed on display 545. For example, if display 545 is configured to include 640×480 pixels, display buffer 535 may include 640×480 storage locations storing pixel color and intensity information, such as red, green, and blue pixel values, or other color values. Display buffer 535 may store the final pixel values for each of the pixels processed by GPU 525. Display 545 may retrieve the final pixel values from display buffer 535 and display the final image based on the pixel values stored in display buffer 535.

User interface unit 505 represents a unit with which a user may interact with or otherwise interface to communicate with other units of device 500, such as CPU 510. Examples of user interface unit 505 include, but are not limited to, a trackball, a mouse, a keyboard, and other types of input devices. User interface unit 505 may also be, or include, a touch screen and the touch screen may be incorporated as part of display 545.

System memory 540 may include one or more computer-readable storage media. Examples of system memory 540 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 540 may store program modules and/or instructions that are accessible for execution by CPU 510. Additionally, system memory 540 may store user applications and application surface data associated with the applications. System memory 540 may in some cases store information for use by and/or information generated by other components of device 500. For example, system memory 540 may act as a device memory for GPU 525 and may store data to be operated on by GPU 555 as well as data resulting from operations performed by GPU 525

In some examples, system memory 540 may include instructions that cause CPU 510 or GPU 525 to perform the functions ascribed to CPU 510 or GPU 525 in aspects of the present disclosure. System memory 540 may, in some examples, be considered as a non-transitory storage medium. The term “non-transitory” should not be interpreted to mean that system memory 540 is non-movable. As one example, system memory 540 may be removed from device 500 and moved to another device. As another example, a system memory substantially similar to system memory 540 may be inserted into device 500. In certain examples, a non-transitory storage medium may store data that can, over time, change (e.g., in RAM).

System memory 540 may store a GPU driver 520 and compiler, a GPU program, and a locally-compiled GPU program. The GPU driver 520 may represent a computer program or executable code that provides an interface to access GPU 525. CPU 510 may execute the GPU driver 520 or portions thereof to interface with GPU 525 and, for this reason, GPU driver 520 is shown in the example of FIG. 5 within CPU 510. GPU driver 520 may be accessible to programs or other executables executed by CPU 510, including the GPU program stored in system memory 540. Thus, when one of the software applications executing on CPU 510 requires graphics processing, CPU 510 may provide graphics commands and graphics data to GPU 525 for rendering to display 545 (e.g., via GPU driver 520).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 525 to execute commands without user knowledge as to the specifics of the hardware components. In order to process the graphics rendering instructions, CPU 510 may issue one or more rendering commands to GPU 525 (e.g., through GPU driver 520) to cause GPU 525 to perform some or all of the rendering of the graphics data. In some examples, the graphics data to be rendered may include a list of graphics primitives (e.g., points, lines, triangles, quadrilaterals, etc.).

The GPU program stored in system memory 540 may invoke or otherwise include one or more functions provided by GPU driver 520. CPU 510 generally executes the program in which the GPU program is embedded and, upon encountering the GPU program, passes the GPU program to GPU driver 520. CPU 510 executes GPU driver 520 in this context to process the GPU program. That is, for example, GPU driver 520 may process the GPU program by compiling the GPU program into object or machine code executable by GPU 525. This object code may be referred to as a locally-compiled GPU program. In some examples, a compiler associated with GPU driver 520 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 510 and GPU 525).

In the example of FIG. 5, the compiler may receive the GPU program from CPU 510 when executing HL code that includes the GPU program. That is, a software application being executed by CPU 510 may invoke GPU driver 520 (e.g., via a graphics API) to issue one or more commands to GPU 525 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 525 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 520 may formulate one or more commands that specify one or more operations for GPU 525 to perform in order to render the primitive. When GPU 525 receives a command from CPU 510, it may decode the command and configure one or more processing elements to perform the specified operation and may output the rendered data to display buffer 535.

GPU 525 may receive the locally-compiled GPU program, and then, in some instances, GPU 525 renders one or more images and outputs the rendered images to display buffer 535. For example, GPU 525 may generate a number of primitives to be displayed at display 545. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 525 for display as an image (or frame in the context of video data) via display 545. GPU 525 may transform primitives and other attributes (e.g., that define a color, texture, lighting, camera configuration, or other aspect) of the primitives into a so-called “world space” by applying one or more model transforms (which may also be specified in the state data). Once transformed, GPU 525 may apply a view transform for the active camera (which again may also be specified in the state data defining the camera) to transform the coordinates of the primitives and lights into the camera or eye space. GPU 525 may also perform vertex shading to render the appearance of the primitives in view of any active lights. GPU 525 may perform vertex shading in one or more of the above model, world, or view space.

Once the primitives are shaded, GPU 525 may perform projections to project the image into a canonical view volume. After transforming the model from the eye space to the canonical view volume, GPU 525 may perform clipping to remove any primitives that do not at least partially reside within the canonical view volume. For example, GPU 525 may remove any primitives that are not within the frame of the camera. GPU 525 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 525 may then rasterize the primitives. Generally, rasterization may refer to the task of taking an image described in a vector graphics format and converting it to a raster image (e.g., a pixelated image) for output on a video display or for storage in a bitmap file format.

A GPU 525 may include a dedicated fast bin buffer (e.g., a fast memory buffer, such as GMEM, which may be referred to by GPU memory 530). As discussed herein, a rendering surface may be divided into bins. In some cases, the bin size is determined by format (e.g., pixel color and depth information) and render target resolution divided by the total amount of GMEM. The number of bins may vary based on device 500 hardware, target resolution size, and target display format. A rendering pass may draw (e.g., render, write, etc.) pixels into GMEM (e.g., with a high bandwidth that matches the capabilities of the GPU). The GPU 525 may then resolve the GMEM (e.g., burst write blended pixel values from the GMEM, as a single layer, to a display buffer 535 or a frame buffer in system memory 540). Such may be referred to as bin-based or tile-based rendering. When all bins are complete, the driver may swap buffers and start the binning process again for a next frame.

For example, GPU 525 may implement a tile-based architecture that renders an image or rendering target by breaking the image into multiple portions, referred to as tiles or bins. The bins may be sized based on the size of GPU memory 530 (e.g., which may alternatively be referred to herein as GMEM or a cache), the resolution of display 545, the color or Z precision of the render target, etc. When implementing tile-based rendering, GPU 525 may perform a binning pass and one or more rendering passes. For example, with respect to the binning pass, GPU 525 may process an entire image and sort rasterized primitives into bins.

The device 500 may use sensor data, sensor statistics, or other data from one or more sensors. Some examples of the monitored sensors may include IMUs, eye trackers, tremor sensors, heart rate sensors, etc. In some cases, an IMU may be included in the device 500, and may measure and report a body's specific force, angular rate, and sometimes the orientation of the body, using some combination of accelerometers, gyroscopes, or magnetometers.

As shown, device 500 may include an extended reality manager 550. The extended reality manager 550 may implement aspects of extended reality, augmented reality, virtual reality, etc. In some cases, such as when the device 500 is implemented as a client device (e.g., device 405 of FIG. 4), the extended reality manager 550 may determine information associated with a user of the device and/or a physical environment in which the device 500 is located, such as facial information, body information, hand information, device pose information, audio information, etc. The device 500 may transmit the information to an animation and scene rendering system (e.g., animation and scene rendering system 410). In some cases, such as when the device 500 is implemented as an animation and scene rendering system (e.g., the animation and scene rendering system 410 of FIG. 4), the extended reality manager 550 may process the information provided by a client device as input information to generate and/or animate a virtual representation for a user of the client device.

Virtual representations (e.g., avatars) are an important component of virtual environments. A virtual representation (or avatar) is a 3D representation of a user and allows the user to interact with the virtual scene. There are different ways to represent a virtual representation of a user (e.g., an avatar) and corresponding animation data. For example, avatars may be purely synthetic or may be an accurate representation of the user (e.g., as shown by the virtual representation 302 shown in the image of FIG. 3).

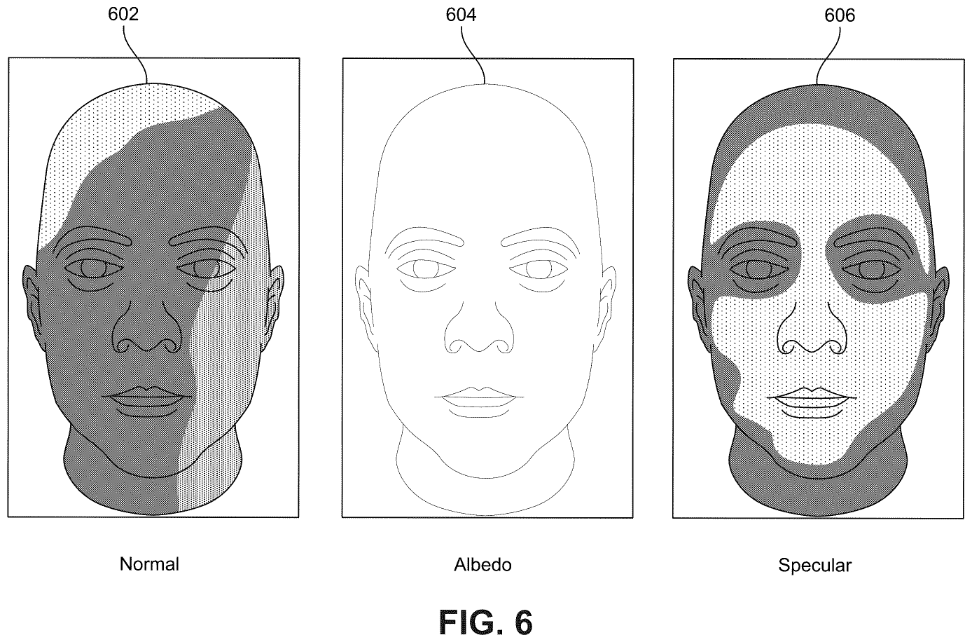

Various animation assets may be needed to model an avatar, including a mesh (e.g., a 3D mesh, such as a triangle mesh, including a plurality of vertices and line segments connected the vertices), a diffuse or albedo texture, normals specular reflection texture, and in some cases other types of textures. These various assets may be available from enrollment or offline reconstruction. FIG. 6 is a diagram illustrating an example of a normal map 602, an albedo map 604, and a specular reflection map 606.

As previously mentioned, XR headset users can be at risk of injury or material damage from an impaired view of their physical surroundings, which can lead to potential collisions with people, pets, or objects. It can be helpful for a system to be able to identify movable objects (e.g., intruders, such as people, pets, or objects) that cause collisions with the user, while balancing power efficiency and performance accuracy. Therefore, improved systems and techniques for determining movable objects that may collide with a XR headset user, while balancing power efficiency and performance accuracy, can be useful.

In one or more aspects, the systems and techniques provide solutions for an efficient dynamic guardian for extended reality, such as virtual reality. In one or more examples, systems and techniques provide solutions for an efficient and high-quality system for alerting users immersed in extended reality (e.g., virtual reality) whenever a movable object (e.g., a person, pet, or robotic device) enters into the user's safe space (e.g., a designated area, referred to as a guardian area, surrounding the user). In some examples, the systems and techniques can ensure power efficiency, while maintaining sufficient accuracy of the alerts.

In one or more examples, the systems and techniques provide for a two-stage hierarchical detection system for extended reality (e.g., virtual reality) environments that efficiently alerts users when a movable object intrudes into the user's safe space (e.g., guardian area). The two-stage hierarchical approach that ensures that minimal computations are performed when no movable object (e.g., intruder) is detected as being near to the guardian area. The two-stage hierarchical detection system includes a classification network stage (e.g., a neural network) and a segmentation and single depth estimation network stage (e.g., a neural network). In the classification network stage, if a movable object (e.g., an intruder) is determined to be located near the user's guardian area, the system triggers operation of the instance segmentation and single depth estimation network stage to determine whether the movable object is located within the user's guardian area. When the instance segmentation and single depth estimation network stage determines that the movable object is located within the user's guardian area, the system will display (e.g., on a display of an XR headset worn by the user) to the user a visual indication of the movable object (e.g., a visual indication around the movable object in the virtual environment) within the user's guardian area (e.g., by blending the visual indication of the movable object, such as a portion of an image including the intruder, into the virtual environment using VST).

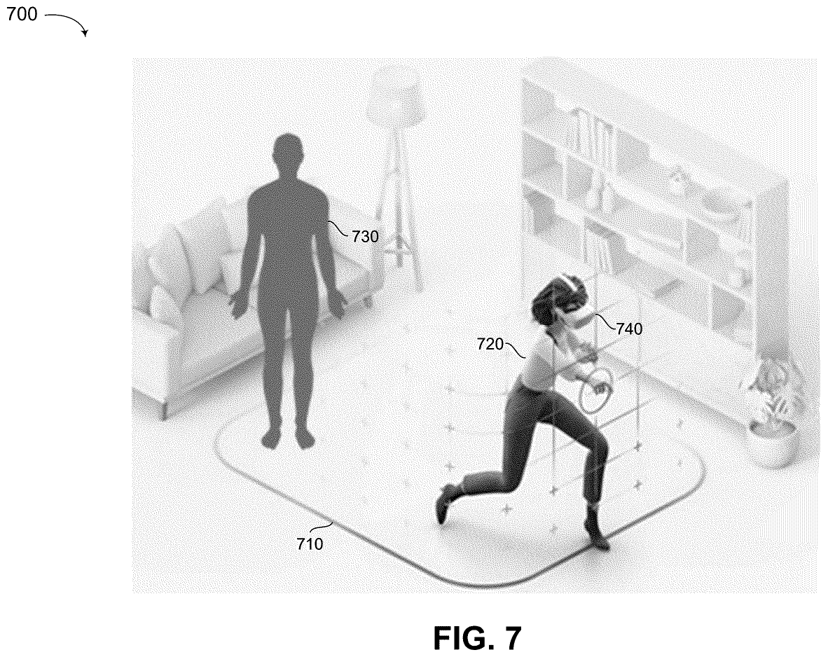

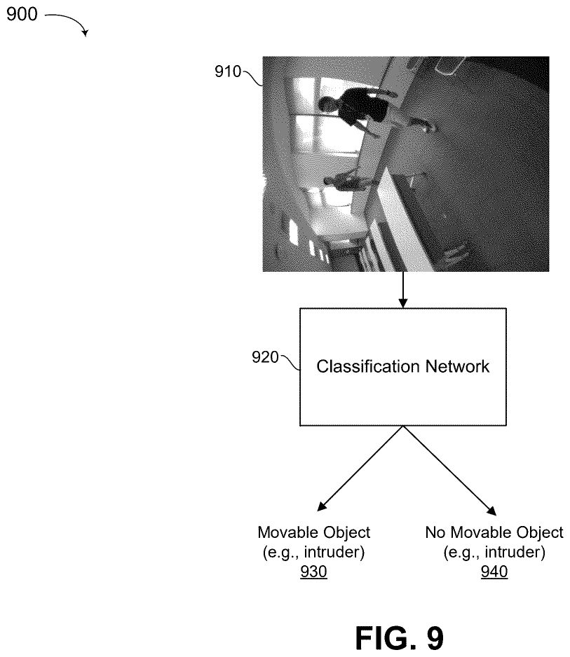

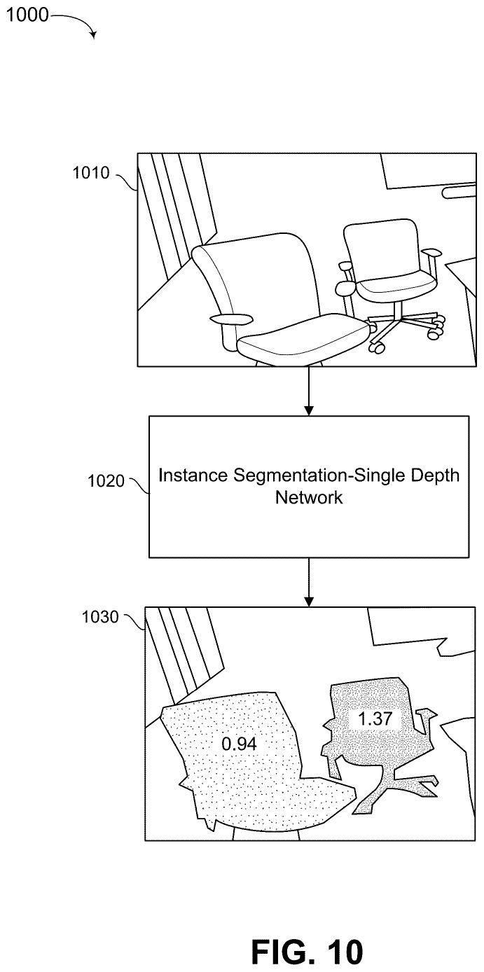

In one or more aspects, during operation of a method for extended reality, a first neural network (e.g., classification network 920 of FIG. 9) may determine, based on a plurality of first images of a scene, whether a movable object (e.g., intruder 730 of FIG. 7) is near an area (e.g., guardian area 710 of FIG. 7) of the scene, wherein the area includes an XR device (e.g., XR device 740 of FIG. 7) worn by a user (e.g., user 720 of FIG. 7). A second neural network (e.g., instance segmentation and single depth network 1020 of FIG. 10) can determine, in response to the first neural network determining the movable object is near the area, whether the movable object is within the area based on a plurality of second images of the scene. A display of the XR device can display (e.g., using VST), to the user in response to the second neural network determining the movable object is within the area, a visual indication of the movable object within the area of the scene. For example, a portion of an image where a movable object is detected can be extracted (e.g., cropped) and blended with virtual content of the virtual environment for display on the display of the XR device (e.g., by using a VST application).

In one or more examples, determining, by the first neural network, whether the movable object is near the area can be based on a distance between the movable object and the area being less than a threshold distance (e.g., two to four meters). In some examples, one or more tracking cameras can obtain the plurality of first images of the scene. In one or more examples, the plurality of first images of the scene can be grayscale images.

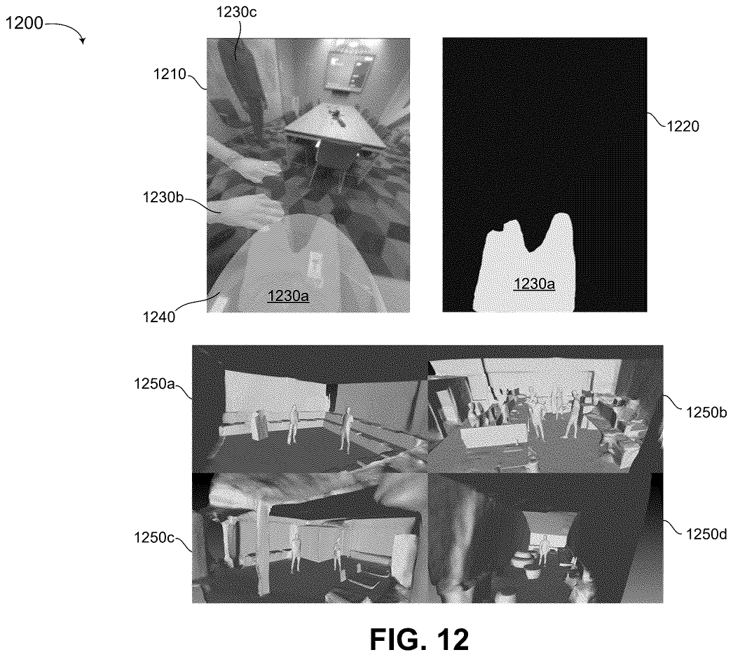

In some examples, determining, by the second neural network, whether the movable object is within the area can be further based on determining one or more segmentation masks (e.g., segmentation masks 1230a, 1230b, 1230c of FIG. 12) for the plurality of second images, where a segmentation mask of the one or more segmentation masks can be associated with the movable object. In one or more examples, determining, by the second neural network, whether the movable object is within the area can be further based on determining a respective depth value for each segmentation mask of the one or more segmentation masks. In some examples, determining, by the second neural network, whether the movable object is within the area can be further based on determining a depth value of the respective depth values is not located within a predefined region (e.g., region 1240 of FIG. 12, which can be produced in an intermediate stage of training data generation, as described below) surrounding the user. In one or more examples, one or more color image sensors can obtain the plurality of second images. In some examples, the plurality of second images can be RGB images.

In one or more examples, the XR device can be a head-mounted device (HMD). In some examples, the first neural network can process the plurality of first images at a first frame rate (e.g., one to two image frames per second), the second neural network can process the plurality of second images at a second frame rate (e.g., fifteen image frames per second), and the first frame rate can be lower than the second frame rate. In some examples, the second neural network can process the plurality of second images at different intervals based on movable object motion (e.g., image frames during intervals where the movable object is not moving much may not be processed). In one or more examples, each first image of the plurality of first images can have a lower resolution (e.g., 400 by 600 pixel resolution) than a resolution (e.g., 2500 by 2500 pixel resolution) of each second image of the plurality of second images. In some examples, the movable object can be a person, animal (e.g., a pet), or robotic device. In one or more examples, the first neural network and the second neural network can be within the XR device.

As mentioned, the systems and techniques can improve the safety of a user using an XR headset. When a user uses an XR headset, the system typically designates a boundary area around the user, where the user is expected to be able to move items within the area. In one or more examples, the boundary area may be an area (e.g., a four foot by four foot area) surrounding the user within a room (e.g., a living room) where the user can freely move to play games or interact with virtual reality content. This area can be referred to as a guardian area. The guardian area can be a safe region for the user to move in while operating the XR device in an immersive virtual reality mode.

While a user is interacting within the guardian area, a movable object or intruder (e.g., which may be in the form of a person, animal, or robotic device) may enter into the area and can pose a potential risk of harm to the user. For example, since the user cannot view the intruder, a potentially harmful scenario may arise where the user may collide with the movable object/intruder.

FIG. 7 shows an example of a guardian area for a user. In particular, FIG. 7 is a diagram illustrating an example of a scene 700 with a guardian area 710 associated with a user 720 wearing an XR device 740. In FIG. 7, the user 720 is shown to be wearing and utilizing the XR device 740 to view virtual reality content. The scene 700 is shown to be located within a living room. The guardian area 710 is shown to be located within the living room and surrounding the user 720.

FIG. 7 also shows an intruder 730, in the form of a person, located within the guardian area 710 associated with the user 720. The intruder 730, being located within the guardian area 710, poses a potential risk of the user 720 colliding with the intruder 730.

In one or more aspects, the systems and techniques provide a dynamic guardian application that detects and displays (e.g., to a user) dynamic intruders (e.g., people and/or pets) entering into the guarding area of the user using an XR device. The dynamic guardian application, upon the detection of an intruder located within the guardian area, can allow for the user to view the intruder via video see through (VST), which blends the intruder's region from the color image sensors.

In one or more examples, the dynamic guardian application should run continuously on the XR device, while the user is operating the XR device (e.g., in virtual reality mode). Since many XR devices run on batteries, it can be essential to minimize the dynamic guardian application's impact on the battery life (e.g., in addition, efficient algorithms can be important). Acquiring image frames from color image sensors (e.g., RGB cameras) for VST can increase the power usage of an XR device. As such, the dynamic guardian application cannot rely solely on RGB images. Balancing of accuracy and power efficiency is important for the operation dynamic guardian application.

In one or more examples, the systems and techniques address challenges that may arise when determining an intruder is present within a guardian area of a user. In one or more examples, the systems and techniques can address a challenge involving the scaling of data. Since the system utilizes machine learning (e.g., the two neural networks), scaling data can be difficult. In one or more examples, a large amount of data is needed (e.g., for training the neural networks) to ensure reasonable generalizability of the disclosed system. For instance segmentation (e.g., which is used by the segmentation and single depth estimation network to identify separate instances of intruders), manual annotation processes are not sufficiently scalable. The systems and techniques use methods other than manual annotation for labeling objects within the scene of a user.

In some examples, the systems and techniques can address a challenge involving ego body distinction. In some examples, dynamic parts (e.g., arms and legs) of the user's own body (e.g., ego body) should not be flagged by the system as being intruders. For example, if the user is looking downwards at his hands and/or legs, the dynamic guardian system should not identify the hands and/or legs of the user as being intruders within the guardian area of the user, but rather should identify the hands and/or legs of the user as being part of the ego body of the user.

In one or more examples, the systems and techniques can address a challenge involving depth labeling. For example, depth sensing equipment (e.g., to obtain depth, which is used by the segmentation and single depth estimation network to identify intruders), such as light detection and ranging (LIDAR) sensors, does not work well to detect dynamic (e.g., moving) entities, such as people and pets. The systems and techniques utilize other methods to obtain the depths for the dynamic entities.

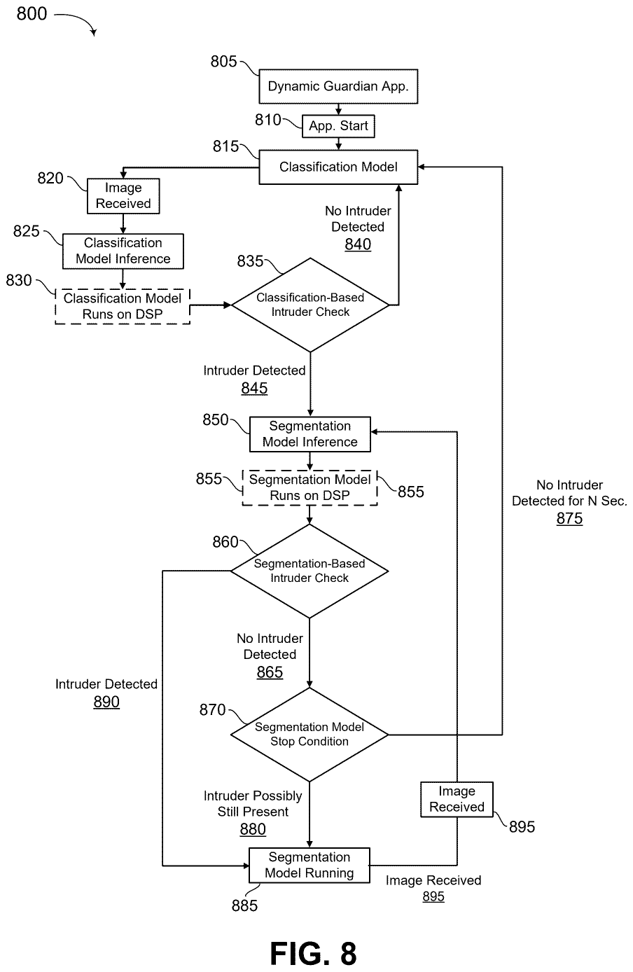

FIG. 8 shows an example process for the disclosed two-stage hierarchical approach. In particular, FIG. 8 is a flow diagram illustrating an example of a process 800 for an efficient dynamic guardian system for identifying intruders within a guardian area of a user using an XR device. In one or more examples, the XR device can run the process 800.

During operation of the process 800, a dynamic guardian application 805 can start 810. At block 815, a classification model (e.g., a first neural network, such as a classification network) is running. At block 825, the classification model can perform an inference (e.g., regarding an intruder) based on one or more received images 820 of a scene including the user. In one or more examples, the one or more received images 820 are grayscale images obtained by one or more tracking cameras of the XR device. The classification model can run on a digital signal processor (DSP) 830.

At decision block 835, the classification model can perform a classification-based intruder check by determining whether an intruder (e.g., a movable object, such as a person, pet, or robotic device) is located near a guardian area associated with a user. The classification model can output true or false, depending upon whether the classification model determines an intruder is located near the guardian area. In one or more examples, the classification model can determine whether there is an intruder near the guardian area based on a distance between the intruder and the guardian area being less than a threshold distance (e.g., two to four feet). If the classification model does not detect an intruder 840 near the guardian area, the process 800 proceeds back to block 815.

However, if the classification model does detect an intruder 845 near the guardian area, the dynamic guardian system switches to (e.g., triggers) a segmentation model (e.g., a second neural network, such as an instance segmentation and single depth estimation network). As such, if the classification model does detect an intruder 845 near the guardian area, at block 850, the segmentation model can perform an inference (e.g., regarding an intruder) based on one or more received images 895 of the scene including the user. In one or more examples, the one or more received images 895 are RGB images obtained by one or more color image sensors of the XR device. In one or more examples, the grayscale images (e.g., received images 820) have a lower resolution than the RGB images (e.g., received images 895). The segmentation model can run on a DSP 855.

At decision block 860, the segmentation model can perform a segmentation-based intruder check by determining whether an intruder (e.g., a movable object, such as a person, pet, or robotic device) is located within the guardian area associated with a user. The segmentation model can output one or more instance segmentation masks (e.g., for one or more potential intruders, such as one instance segmentation mask around each detected intruder) within the scene. The one or more instance segmentation masks can include associated depth values (e.g., a single depth value associated with or assigned to each entire segmentation mask, a particular depth value for each pixel of each instance segmentation mask, or other number of depth values) and a probability values (e.g., a single probability value associated with or assigned to the entire segmentation mask, a particular probability for each pixel of each instance segmentation mask, or other number of probability values). For example, the one or more instance segmentation masks can include a single associated depth value and a single probability value for each segmentation mask. The probability value for each instance segmentation mask includes the likelihood of whether the mask belongs to an intruder or to a user of the XR device (e.g., referred to as an ego-body). The segmentation model can determine the segmentation masks using one or more RGB images (e.g., received images 895) obtained by one or more color image sensors. obtained by one or more color image sensors.

The segmentation model can determine whether there is an intruder within the guardian area further based on determining a respective single depth value and a corresponding probability (e.g., a single probability) for each segmentation mask (e.g., each associated with a potential intruder). The check at decision block 860 can be performed by determining whether the probability (e.g., the single probability indicating whether a segmentation mask belongs to an intruder or to a user of the XR device) of each segmentation mask is greater than a threshold probability (indicating that the object is a movable object, such as an intruder) and by determining whether the depth of each segmentation mask is less than a depth threshold (indicating that the movable object is within a certain distance from the XR device and thus within the guardian area). The threshold probability can be set to any suitable value, such as 50%, 60%, 75%, or other value. The depth threshold can be set to any suitable value, such as 0.5 meters, 1 meter, 1.5 meters, or other depth threshold. In one illustrative example, the check at decision block 860 can detect an intruder is present based on determining the probability (e.g., the single probability) of a segmentation mask is greater than 50%. The depth output from the segmentation model can then be used to check whether the movable object is in the guardian area. For example, the check at decision block 860 can determine that the detected intruder is within the guardian area (an intruder detected decision 890) in response to determining that the single depth value associated with the segmentation mask of the detected movable object is less than a depth threshold value of 0.5 meters. In some aspects, the segmentation model can determine whether there is an intruder within the guardian area further based on determining a depth value associated with a segmentation mask is not located within a predefined region (e.g., a cone located adjacent to the user, where segmentation masks for objects detected within the cone are determined to be part of the user's body). In one or more examples, the segmentation model can process the RGB images (e.g., received images 895) at a first frame rate. The classification model can process the grayscale images (e.g., received images 820) at a second frame rate. In some examples, the second frame rate is lower than the first frame rate.

If, at decision block 860, the segmentation model does detect an intruder (the intruder detected decision 890) within the guardian area, the segmentation model continues running at block 885. However, if at decision block 860 the segmentation model does not detect an intruder (a no intruder detected decision 865) within the guardian area, the segmentation model can continue to perform a segmentation-based intruder check by determining whether an intruder (e.g., a movable object, such as a person, pet, or robotic device) is located within the guardian area associated with a user. The segmentation model will continue to run this check until a stop condition occurs, as determined at decision block 870. In one or more examples, the stop condition is that no intruder is determined to be located within the guardian area for N number of seconds.

If no intruders were determined to be within the guardian area and the N number of seconds has not expired, the intruder could still be within the guardian area of the user 880, and the process 800 can proceed to block 885. However, if no intruders were determined to be within the guardian area within the N number of seconds 875 (e.g., the N number of seconds has expired), the process 800 can proceed back to block 815.

FIG. 9 shows an example process for a classification network. In particular, FIG. 9 is a diagram illustrating an example of a process 900 for a classification network to identify an intruder located near a guardian area of a user using an XR device. In FIG. 9, the classification network 920 is shown to receive an image 910 of a scene including the user. In one or more examples, the image 910 is a grayscale image obtained from a tracking camera. The classification network 920 can run on images from tracking cameras on the XR device. The tracking images are already required by other vital components of the XR system (e.g., for head tracking) and, as such, there is no additional cost associated with their acquisition. These tracking images are inherently cheaper to acquire than the RGB images, and provide a larger field of view (FOV) than RGB images.

In one or more examples, the classification network 920 can determine, based on the image 910, whether an intruder is located near the guardian area of the user (intruder 930) or is not located near the guardian area (no intruder 940). The classification network 920 can be trained to signal (e.g., report) to the system whether (or not) an intruder is located near the guardian area of the user. This way, by the time the intruder will enter into the guardian area, the dynamic guardian system will have enough time to turn on the RGB frame acquisition and start executing the higher computational instance segmentation and single depth estimation model.

In one or more examples, the classification network 920 can process one to two image frames per second. For an average case where there are no intruders, running at this frequency (e.g., frame rate) can allow for minimal power consumption by the XR device.

FIG. 10 shows an example process for a segmentation network. In particular, FIG. 10 is a diagram illustrating an example of a process 1000 for an instance segmentation and single depth network 1020 (e.g., segmentation network) to identify an intruder located within the guardian area of a user.

In one or more examples, the instance segmentation and single depth network 1020 performs instance segmentation trained on movable objects, such as humans and animals (e.g., pets), to distinguish between the user's own body (ego body) and other intruders located within the scene and to associate one single depth value to each instance (e.g., identified by a segmentation mask) that is detected. For the instance segmentation and single depth network 1020, an convolutional architecture can be used that includes a linear layer (to enable single depth prediction for each instance segmentation mask), such as a fully connected layer, added to a part of the network.

In FIG. 10, the instance segmentation and single depth network 1020 is shown to receive an image 1010 of a scene including the user. In one or more examples, the image 1010 is an RGB image obtained from a color image sensor. The instance segmentation and single depth network 1020 can run on images from color images sensors on the XR device. In one or more examples, the instance segmentation and single depth network 1020 can determine, based on the image 1010, whether an intruder is located within the guardian area of the user. In some examples, determining whether an intruder is located within the guardian area of the user is based on determining a segmentation mask for each potential intruder. The instance segmentation and single depth network 1020 can generate a segmentation map 1030 (e.g., including the segmentation masks) based on the image 1010.

There are alternative approaches (e.g., running a separate network for dense depth estimation, human pose estimation, human bounding box detection, triangulation, etc.) that may be used to detect intruders. However, these alternative approaches would either result in a higher power consumption or in a lower fidelity intruder masks.

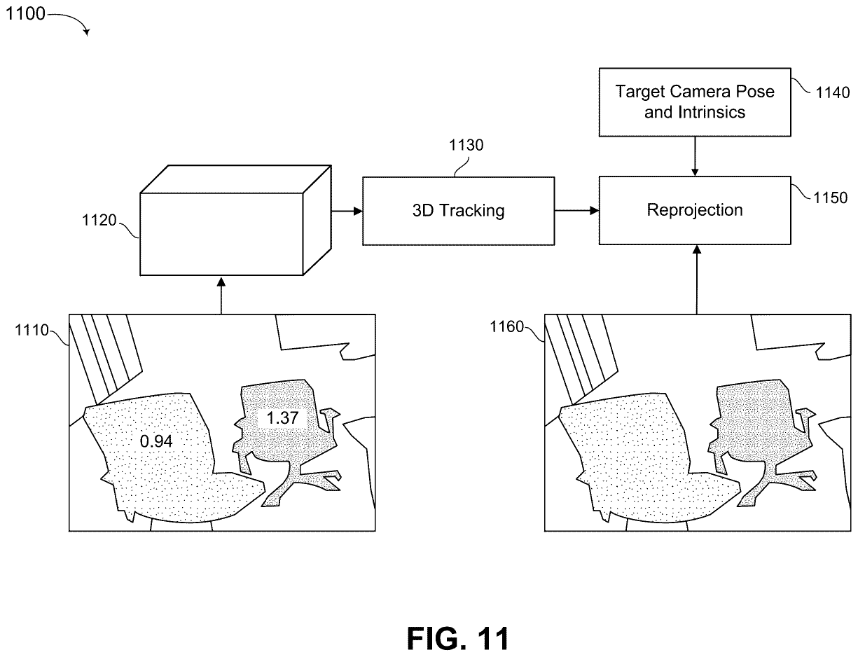

FIG. 11 shows an example process for efficient 3D tracking of intruders. In particular, FIG. 11 is a diagram illustrating an example of a process 1100 for efficient 3D tracking of intruders. For efficient 3D tracking of intruders, even when intruders are present, it is not necessary to run the segmentation model on all of the received RGB image frames. It is expected that there is a specific interval of image frames (e.g., to be found empirically) for which the intruder motion is minimal and, as such, the user's head movement may be considered instead of processing the image frames.

In order to conserve power of the XR device, the segmentation model can avoid running (e.g., processing) the image frames within that interval. Instead, predictions from previous image frames can be propagated to new image frames. This propagation can be achieved by back-projecting the instance segmentation masks in 3D using their associated the depth values, tracking in 3D (e.g., to obtain the head pose), and then reprojecting the point cloud onto the new image frames using the known intrinsics and poses of the target camera (e.g., related to the head pose).

In FIG. 11, an RGB image 1110 of a scene can be obtained by a color image sensor 1120 of an XR device. The XR device can perform 3D tracking 1130 to obtain a head pose of the user. A point cloud (e.g., from the image 1110) can be reprojected 1150, based on the 3D tracking 1130 and the target camera pose and intrinsics 1140, onto a new image frame 116t0.

FIG. 12 shows examples of segmentation masks for potential intruders. In particular, FIG. 12 is a diagram illustrating examples 1200 of segmentation masks 1230a, 1230b, 1230c of potential intruders in a guardian area of a user. In FIG. 12, segmentation map 1210 shows three segmentation masks 1230a (e.g., a segmentation mask associated with the user's legs), 1230b (e.g., a segmentation mask associated with an intruder's hands), 1230c (e.g., a segmentation mask associated with an intruder's body). The segmentation map 1210 also shows a predefined region 1240 (e.g., in the form of a semicircle-like structure, such as a cone). The predefined region 1240 can be produced in an intermediate stage of training data generation. In FIG. 12, image 1220 shows the segmentation mask 1230a, which has been extracted from the segmentation map 1210.

In one or more examples, for generating segmentation maps for intruders, a segmentation application can be run on an image of the scene to generate segmentation maps 1230a, 1230b, 1230c that each correspond to a potential intruder. A tracker (e.g., a 6 DOF tracker) can then be used to fit a gravity-aligned cone around the user. An inertial measurement unit (IMU) within the tracker can be used to determine the vertical line for gravity. The vertical line can be aligned with the length of the user's body and the length of the cone in order to align the cone with the user's body. Movable objects associated with segmentation masks that fall inside of the cone or have a significant overlap ratio with the cone are not determined to be an intruder, but rather can be determined to be the user's body (e.g., the ego body). In FIG. 11, the segmentation mask 1230a falls inside of the cone 1240 and, as such, the movable object associated with the segmentation mask 1230a can be determined to be associated with the user's body. This data-driven way of dealing with the ego body can ensure that no additional complexity needs to be added to the system at the inference time, which can further contribute to power efficiency.

In one or more examples, the depth values associated with the segmentation masks can also be modified by using a rescaling operation based on either the sparse points from the tracker or the depths from a time of flight (ToF) camera. FIG. 12 also shows images 1250a, 1250b, 1250c, 1250d showing neural representations of scenes containing humans. In some aspects, the depth values can be modified using the rescaling operation for training only, based on the neural networks used to generate depth data for training requiring such a step. For example, the depth values output by such neural networks may not be a real metric depth, but may be a relative depth (e.g., a transformation of the metric depth). The parameters of this transformation can be recovered using the rescale operation.

As described herein, the systems described herein can utilize one or more machine learning models (e.g., one or more neural networks). FIG. 13 is an illustrative example of a neural network 1300 (e.g., a deep-learning neural network) that can be implemented within one or more components of the disclosed systems.

Neural network 1300 includes multiple hidden layers hidden layers 1306a, 1306b, through 1306n. The hidden layers 1306a, 1306b, through hidden layer 1306n include “n” number of hidden layers, where “n” is an integer greater than or equal to one. The number of hidden layers can be made to include as many layers as needed for the given application. Neural network 1300 further includes an output layer 1304 that provides an output resulting from the processing performed by the hidden layers 1306a, 1306b, through 1306n.

Neural network 1300 may be, or may include, a multi-layer neural network of interconnected nodes. Each node can represent a piece of information. Information associated with the nodes is shared among the different layers and each layer retains information as information is processed. In some cases, neural network 1300 can include a feed-forward network, in which case there are no feedback connections where outputs of the network are fed back into itself. In some cases, neural network 1300 can include a recurrent neural network, which can have loops that allow information to be carried across nodes while reading in input.

Information can be exchanged between nodes through node-to-node interconnections between the various layers. Nodes of input layer 1302 can activate a set of nodes in the first hidden layer 1306a. For example, as shown, each of the input nodes of input layer 1302 is connected to each of the nodes of the first hidden layer 1306a. The nodes of first hidden layer 1306a can transform the information of each input node by applying activation functions to the input node information. The information derived from the transformation can then be passed to and can activate the nodes of the next hidden layer 1306b, which can perform their own designated functions. Example functions include convolutional, up-sampling, data transformation, and/or any other suitable functions. The output of the hidden layer 1306b can then activate nodes of the next hidden layer, and so on. The output of the last hidden layer 1306n can activate one or more nodes of the output layer 1304, at which an output is provided. In some cases, while nodes (e.g., node 1308) in neural network 1300 are shown as having multiple output lines, a node has a single output and all lines shown as being output from a node represent the same output value.

In some cases, each node or interconnection between nodes can have a weight that is a set of parameters derived from the training of neural network 1300. Once neural network 1300 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1300 to be adaptive to inputs and able to learn as more and more data is processed.

Neural network 1300 may be pre-trained to process the features from the data in the input layer 1302 using the different hidden layers 1306a, 1306b, through 1306n in order to provide the output through the output layer 1304. In an example in which neural network 1300 is used to identify features in images, neural network 1300 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0010000000].

In some cases, neural network 1300 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1300 is trained well enough so that the weights of the layers are accurately tuned.

For the example of identifying objects in images, the forward pass can include passing a training image through neural network 1300. The weights are initially randomized before neural network 1300 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1300, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1300 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( t arget - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1300 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

Neural network 1300 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1300 can include any other deep network other than a CNN, such as an autoencoder, a deep belief nets (DBNs), a Recurrent Neural Networks (RNNs), among others.

FIG. 14 is an illustrative example of a convolutional neural network 1400 (CNN 1400). The input layer 1420 of the CNN 1400 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1422a, an optional non-linear activation layer, a pooling hidden layer 1422b, and fully connected hidden layers 1422c to get an output at the output layer 1424. While only one of each hidden layer is shown in FIG. 14, one of ordinary skill will appreciate that multiple convolutional hidden layers, non-linear layers, pooling hidden layers, and/or fully connected layers can be included in the CNN 1400. As previously described, the output can indicate a single class of an object or can include a probability of classes that best describe the object in the image.

The first layer of the CNN 1400 is the convolutional hidden layer 1422a. The convolutional hidden layer 1422a analyzes the image data of the input layer 1420. Each node of the convolutional hidden layer 1422a is connected to a region of nodes (pixels) of the input image called a receptive field. The convolutional hidden layer 1422a can be considered as one or more filters (each filter corresponding to a different activation or feature map), with each convolutional iteration of a filter being a node or neuron of the convolutional hidden layer 1422a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1422a. Each connection between a node and a receptive field for that node learns a weight and, in some cases, an overall bias such that each node learns to analyze its particular local receptive field in the input image. Each node of the hidden layer 1422a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1422a is due to each node of the convolutional layer being applied to its corresponding receptive field. For example, a filter of the convolutional hidden layer 1422a can begin in the top-left corner of the input image array and can convolve around the input image. As noted above, each convolutional iteration of the filter can be considered a node or neuron of the convolutional hidden layer 1422a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1422a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1422a.

The mapping from the input layer to the convolutional hidden layer 1422a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1422a can include several activation maps in order to identify multiple features in an image. The example shown in FIG. 14 includes three activation maps. Using three activation maps, the convolutional hidden layer 1422a can detect three different kinds of features, with each feature being detectable across the entire image.

In some examples, a non-linear hidden layer can be applied after the convolutional hidden layer 1422a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1400 without affecting the receptive fields of the convolutional hidden layer 1422a.

The pooling hidden layer 1422b can be applied after the convolutional hidden layer 1422a (and after the non-linear hidden layer when used). The pooling hidden layer 1422b is used to simplify the information in the output from the convolutional hidden layer 1422a. For example, the pooling hidden layer 1422b can take each activation map output from the convolutional hidden layer 1422a and generates a condensed activation map (or feature map) using a pooling function. Max-pooling is one example of a function performed by a pooling hidden layer. Other forms of pooling functions be used by the pooling hidden layer 1422a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1422a. In the example shown in FIG. 14, three pooling filters are used for the three activation maps in the convolutional hidden layer 1422a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1422a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1422a having a dimension of 24×24 nodes, the output from the pooling hidden layer 1422b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1400.

The final layer of connections in the network is a fully-connected layer that connects every node from the pooling hidden layer 1422b to every one of the output nodes in the output layer 1424. Using the example above, the input layer includes 28×28 nodes encoding the pixel intensities of the input image, the convolutional hidden layer 1422a includes 3×24×24 hidden feature nodes based on application of a 5×5 local receptive field (for the filters) to three activation maps, and the pooling layer 1422b includes a layer of 3×12×12 hidden feature nodes based on application of max-pooling filter to 2×2 regions across each of the three feature maps. Extending this example, the output layer 1424 can include ten output nodes. In such an example, every node of the 3×12×12 pooling hidden layer 1422b is connected to every node of the output layer 1424.

The fully connected layer 1422c can obtain the output of the previous pooling layer 1422b (which should represent the activation maps of high-level features) and determines the features that most correlate to a particular class. For example, the fully connected layer 1422c layer can determine the high-level features that most strongly correlate to a particular class, and can include weights (nodes) for the high-level features. A product can be computed between the weights of the fully connected layer 1422c and the pooling hidden layer 1422b to obtain probabilities for the different classes. For example, if the CNN 1400 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1424 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

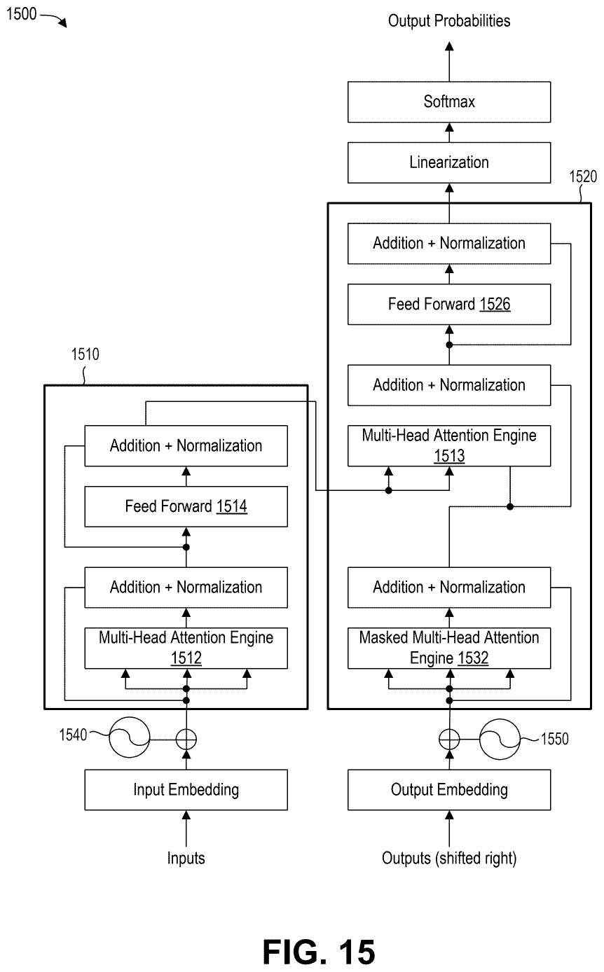

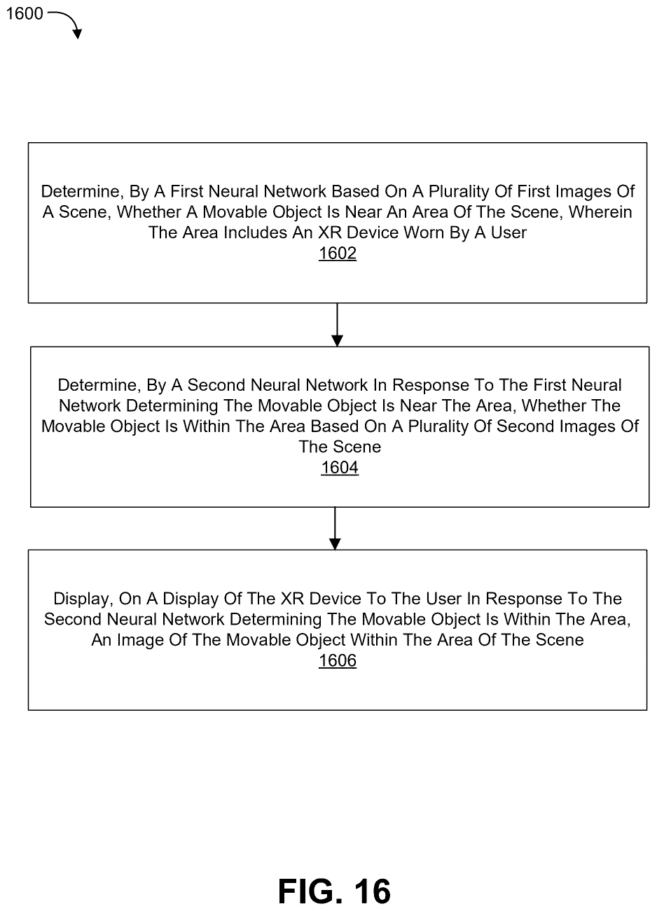

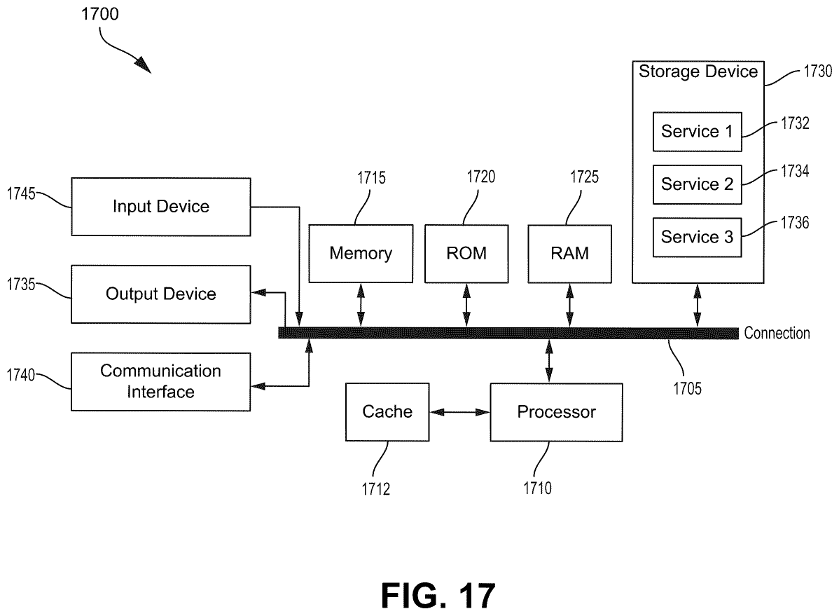

FIG. 15 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 1500 reduces the operations of learning dependencies by using an encoder 1510 and a decoder 1520 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1510 is composed of a stack of six identical layers and each layer has two sub-layers. The first sub-layer is a multi-head self-attention engine 1512, and the second sub-layer is a fully connected feed-forward network 1514. A residual connection (not shown) connects around each of the sub-layers followed by normalization.

In this example transformer 1500, the decoder 1520 is also composed of a stack of six 6 identical layers. The decoder also includes a masked multi-head self-attention engine 1532, a multi-head attention engine 1513 over the output of the encoder 1510, and a fully connected feed-forward network 1526. Each layer includes a residual connection (not shown) around the layer, which is followed by layer normalization. The masked multi-head self-attention engine 1532 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1540 to encode positions because the model does not contain recurrence and convolution and relative or absolute position of the tokens is needed. In the transformer 1500, the positional encodings are added to the input embeddings at the bottom layer of the encoder 1510 and the decoder 1520. The positional encodings are summed with the embeddings because the positional encodings and embeddings have the same dimensions. A corresponding position decoder 1550 is configured to decode the positions of the embeddings for the decoder 1520.

In some aspects, the transformer 1500 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1500 can process input sequences of variable length, making it well-suited for natural language processing tasks where input lengths can vary greatly. Additionally, the self-attention mechanism allows the transformer 1500 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 16 is a flow chart illustrating an example of a process 1600 for extended reality. The process 1600 can be performed by a computing device (e.g., a computing device or computing system 1700 of FIG. 17) or by a component or system (e.g., a chipset, one or more processors central processing units (CPUs), digital signal processors (DSPs), graphics processing units (GPUs), neural processing units (NPUs), neural signal processors (NSPs), any combination thereof, and/or other type of processor(s), or other component or system) of the computing device. In some aspects, the computing device is an XR device worn by a user or is part of the XR device (e.g., a component of the XR device, such as a CPU, DSP, GPU, NPU, NSP, etc.). In some cases, the XR device is a head-mounted device. The operations of the process 1600 may be implemented as software components that are executed and run on one or more processors (e.g., processor 1710 of FIG. 17, or other processor(s)). Further, the transmission and reception of signals by the computing device in the process 1600 may be enabled, for example, by one or more antennas and/or one or more transceivers (e.g., wireless transceiver(s)).

At block 1602, the computing device (or component thereof) can determine, using a first neural network (e.g., the classification network 920 of FIG. 9) based on a plurality of first images of a scene, whether a movable object is near an area of the scene (e.g., as determined at decision block 835 of FIG. 8). The movable object can be a person, animal, a movable robotic device, or other type of movable object that can move in and out of the area. The area includes the XR device worn by the user (e.g., the guardian area 710 in which the user 720 of the XR device 740 is located, as shown in FIG. 7). In some aspects, the computing device (or component thereof) can obtain, from one or more tracking cameras of the XR device, the plurality of first images of the scene. In some cases, the plurality of first images of the scene are grayscale images.

At block 1604, the computing device (or component thereof) can determine, using a second neural network (e.g., the instance segmentation-single depth network 1020 of FIG. 10) in response to the first neural network determining the movable object is near the area, whether the movable object is within the area based on a plurality of second images of the scene (e.g., as determined at decision block 860 of FIG. 8). In some aspects, the computing device (or component thereof) can determine, using the first neural network, whether the movable object is near the area is based on a distance between the movable object and the area being less than a threshold distance (e.g., one meter, two meters, four meters, or other threshold distance). In some cases, the computing device (or component thereof) can obtain, from one or more color image sensors of the XR device, the plurality of second images. In some examples, each first image of the plurality of first images has a lower resolution than each second image of the plurality of second images.

In some aspects, the computing device (or component thereof) can process the plurality of first images using the first neural network at a first frame rate. The computing device (or component thereof) can process the plurality of second images using the second neural network at a second frame rate, where the first frame rate is lower than the second frame rate. In some cases, the computing device (or component thereof) can process the plurality of second images using the second neural network at different intervals based on movable object motion. In some aspects, the first neural network and the second neural network are within the XR device (e.g., stored in memory of the XR device, executed by at least one processor of the XR device, etc.).

In some aspects, the computing device (or component thereof) can determine one or more segmentation masks for the plurality of second images. For example, a segmentation mask (e.g., an instance segmentation mask) of the one or more segmentation masks is associated with the movable object (e.g., one segmentation mask is determined for each movable object detected in each of the plurality of second images). In some cases, to determine using the second neural network whether the movable object is within the area, the computing device (or component thereof) can determine a respective depth value for each segmentation mask of the one or more segmentation masks. For instance, as described previously, the check at decision block 860 can include checking whether the probability (e.g., the single probability indicating whether the pixel belongs to an intruder or to a user of the XR device) of each segmentation mask is greater than a threshold probability (e.g., a threshold probability value of 50%, 60%, 75%, or other value). In one illustrative example, an intruder can be detected within the guardian area (an intruder detected decision 890) based on determining the probability (e.g., the single probability) of a segmentation mask for is greater than 60%. In some examples, to determine using the second neural network whether the movable object is within the area, the computing device (or component thereof) can determine a depth value of the respective depth values is not located within a predefined region surrounding the user (e.g., by determining the depth value is not part of the user of the XR device).

At block 1606, the computing device (or component thereof) can display (or output for display), on a display of the XR device to the user in response to the second neural network determining the movable object is within the area, a visual indication of the movable object (e.g., a visual indication around the movable object in the virtual environment) within the area of the scene. For example, a portion of an image where a movable object is detected can be extracted (e.g., cropped) and blended with virtual content of the virtual environment for display on the display of the XR device (e.g., by using a VST application).

In some cases, the computing device of process 1600 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1600 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1600 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1600 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 17 is a block diagram illustrating an example of a computing system 1700, which may be employed for an efficient dynamic guardian for extended reality, such as virtual reality. In particular, FIG. 17 illustrates an example of computing system 1700, which can be for example any computing device making up internal computing system, a remote computing system, a camera, or any component thereof in which the components of the system are in communication with each other using connection 1705. Connection 1705 can be a physical connection using a bus, or a direct connection into processor 1710, such as in a chipset architecture. Connection 1705 can also be a virtual connection, networked connection, or logical connection.

In some aspects, computing system 1700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example E system 1700 includes at least one processing unit (CPU or processor) 1710 and connection 1705 that communicatively couples various system components including system memory 1715, such as read-only memory (ROM) 1720 and random access memory (RAM) 1725 to processor 1710. Computing system 1700 can include a cache 1712 of high-speed memory connected directly with, in close proximity to, or integrated as part of processor 1710.

Processor 1710 can include any general purpose processor and a hardware service or software service, such as services 1732, 1734, and 1736 stored in storage device 1730, configured to control processor 1710 as well as a special-purpose processor where software instructions are incorporated into the actual processor design. Processor 1710 may essentially be a completely self-contained computing system, containing multiple cores or processors, a bus, memory controller, cache, etc. A multi-core processor may be symmetric or asymmetric.

To enable user interaction, computing system 1700 includes an input device 1745, which can represent any number of input mechanisms, such as a microphone for speech, a touch-sensitive screen for gesture or graphical input, keyboard, mouse, motion input, speech, etc. Computing system 1700 can also include output device 1735, which can be one or more of a number of output mechanisms. In some instances, multimodal systems can enable a user to provide multiple types of input/output to communicate with computing system 1700.

Computing system 1700 can include communications interface 1740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1740 may also include one or more range sensors (e.g., LiDAR sensors, laser range finders, RF radars, ultrasonic sensors, and infrared (IR) sensors) configured to collect data and provide measurements to processor 1710, whereby processor 1710 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1740 may also include one or more receivers or transceivers that are used to determine a location of the computing system 1700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1730 can include software services, servers, services, etc., that when the code that defines such software is executed by the processor 1710, it causes the system to perform a function. In some aspects, a hardware service that performs a particular function can include the software component stored in a computer-readable medium in connection with the necessary hardware components, such as processor 1710, connection 1705, output device 1735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

| Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for extended reality (XR), the apparatus comprising: at least one memory; and at least one processor coupled to the at least one memory and configured to: determine, using a first neural network based on a plurality of first images of a scene, whether a movable object is near an area of the scene, wherein the area includes an XR device worn by a user; determine, using a second neural network in response to the first neural network determining the movable object is near the area, whether the movable object is within the area based on a plurality of second images of the scene; and output, for display on a display of the XR device to the user in response to the second neural network determining the movable object is within the area, a visual indication of the movable object within the area of the scene.

Aspect 2. The apparatus of Aspect 1, wherein the at least one processor is configured to determine, using the first neural network, whether the movable object is near the area is based on a distance between the movable object and the area being less than a threshold distance.

Aspect 3. The apparatus of any of Aspects 1 or 2, wherein the at least one processor is configured to obtain, from one or more tracking cameras of the XR device, the plurality of first images of the scene.

Aspect 4. The apparatus of any of Aspects 1 to 3, wherein the plurality of first images of the scene are grayscale images.

Aspect 5. The apparatus of any of Aspects 1 to 4, wherein, to determine using the second neural network whether the movable object is within the area, the at least one processor is configured to determine one or more segmentation masks for the plurality of second images, wherein a segmentation mask of the one or more segmentation masks is associated with the movable object.

Aspect 6. The apparatus of Aspect 5, wherein, to determine using the second neural network whether the movable object is within the area, the at least one processor is configured to determine a respective depth value for each segmentation mask of the one or more segmentation masks.

Aspect 7. The apparatus of Aspect 6, wherein, to determine using the second neural network whether the movable object is within the area, the at least one processor is configured to determine a depth value of the respective depth values is not located within a predefined region surrounding the user.

Aspect 8. The apparatus of any of Aspects 1 to 7, wherein the at least one processor is configured to obtain, from one or more color image sensors of the XR device, the plurality of second images.

Aspect 9. The apparatus of any of Aspects 1 to 8, wherein the apparatus is the XR device or part of the XR device.

Aspect 10. The apparatus of any of Aspects 1 to 9, wherein the XR device is a head-mounted device.

Aspect 11. The apparatus of any of Aspects 1 to 10, wherein the at least one processor is configured to: process the plurality of first images using the first neural network at a first frame rate; and process the plurality of second images using the second neural network at a second frame rate, wherein the first frame rate is lower than the second frame rate.

Aspect 12. The apparatus of any of Aspects 1 to 11, wherein the at least one processor is configured to process the plurality of second images using the second neural network at different intervals based on movable object motion.

Aspect 13. The apparatus of any of Aspects 1 to 12, wherein each first image of the plurality of first images has a lower resolution than each second image of the plurality of second images.

Aspect 14. The apparatus of any of Aspects 1 to 13, wherein the movable object is a person, animal, or robotic device.

Aspect 15. The apparatus of any of Aspects 1 to 14, wherein the first neural network and the second neural network are within the XR device.

Aspect 16. A method for extended reality (XR), the method comprising: determining, by a first neural network based on a plurality of first images of a scene, whether a movable object is near an area of the scene, wherein the area includes an XR device worn by a user; determining, by a second neural network in response to the first neural network determining the movable object is near the area, whether the movable object is within the area based on a plurality of second images of the scene; and displaying, on a display of the XR device to the user in response to the second neural network determining the movable object is within the area, a visual indication of the movable object within the area of the scene.

Aspect 17. The method of Aspect 16, further comprising determining, by the first neural network, whether the movable object is near the area is based on a distance between the movable object and the area being less than a threshold distance.

Aspect 18. The method of any of Aspects 16 or 17, wherein the at least one processor is configured to obtain, from one or more tracking cameras of the XR device, the plurality of first images of the scene.

Aspect 19. The method of any of Aspects 16 to 18, wherein the plurality of first images of the scene are grayscale images.

Aspect 20. The method of any of Aspects 16 to 19, wherein determining, by the second neural network, whether the movable object is within the area is further based on determining one or more segmentation masks for the plurality of second images, wherein a segmentation mask of the one or more segmentation masks is associated with the movable object.

Aspect 21. The method of Aspect 20, wherein determining, by the second neural network, whether the movable object is within the area is further based on determining a respective depth value for each segmentation mask of the one or more segmentation masks.

Aspect 22. The method of Aspect 21, wherein determining, by the second neural network, whether the movable object is within the area is further based on determining a depth value of the respective depth values is not located within a predefined region surrounding the user.

Aspect 23. The method of any of Aspects 16 to 22, wherein the at least one processor is configured to obtain, from one or more color image sensors of the XR device, the plurality of second images.

Aspect 24. The method of any of Aspects 16 to 23, wherein the apparatus is the XR device or part of the XR device.

Aspect 25. The method of any of Aspects 16 to 24, wherein the XR device is a head-mounted device.

Aspect 26. The method of any of Aspects 16 to 25, wherein the at least one processor is configured to: process the plurality of first images using the first neural network at a first frame rate; and process the plurality of second images using the second neural network at a second frame rate, wherein the first frame rate is lower than the second frame rate.

Aspect 27. The method of any of Aspects 16 to 26, wherein the at least one processor is configured to process the plurality of second images using the second neural network at different intervals based on movable object motion.

Aspect 28. The method of any of Aspects 16 to 27, wherein each first image of the plurality of first images has a lower resolution than each second image of the plurality of second images.

Aspect 29. The method of any of Aspects 16 to 28, wherein the movable object is a person, animal, or robotic device.

Aspect 30. The method of any of Aspects 16 to 29, wherein the first neural network and the second neural network are within the XR device.

Aspect 31. A non-transitory computer-readable medium having stored thereon instructions that, when executed by at least one processor, cause the at least one processor to perform operations according to any of Aspects 16 to 30.

Aspect 32. An apparatus for extended reality (XR), the apparatus including one or more means for performing operations according to any of Aspects 16 to 30.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for extended reality (XR), the apparatus comprising:
at least one memory; and
at least one processor coupled to the at least one memory and configured to:
determine, using a first neural network based on a plurality of first images of a scene, whether a movable object is near an area of the scene, wherein the area includes an XR device worn by a user;
determine, using a second neural network in response to the first neural network determining the movable object is near the area, whether the movable object is within the area based on a plurality of second images of the scene; and
output, for display on a display of the XR device to the user in response to the second neural network determining the movable object is within the area, a visual indication of the movable object within the area of the scene.

2. The apparatus of claim 1, wherein the at least one processor is configured to determine, using the first neural network, whether the movable object is near the area is based on a distance between the movable object and the area being less than a threshold distance.

3. The apparatus of claim 1, wherein the at least one processor is configured to obtain, from one or more tracking cameras of the XR device, the plurality of first images of the scene.

4. The apparatus of claim 1, wherein the plurality of first images of the scene are grayscale images.

5. The apparatus of claim 1, wherein, to determine using the second neural network whether the movable object is within the area, the at least one processor is configured to determine one or more segmentation masks for the plurality of second images, wherein a segmentation mask of the one or more segmentation masks is associated with the movable object.

6. The apparatus of claim 5, wherein, to determine using the second neural network whether the movable object is within the area, the at least one processor is configured to determine a respective depth value for each segmentation mask of the one or more segmentation masks.

7. The apparatus of claim 6, wherein, to determine using the second neural network whether the movable object is within the area, the at least one processor is configured to determine a depth value of the respective depth values is not located within a predefined region surrounding the user.

8. The apparatus of claim 1, wherein the at least one processor is configured to obtain, from one or more color image sensors of the XR device, the plurality of second images.

9. The apparatus of claim 1, wherein the apparatus is the XR device or part of the XR device.

10. The apparatus of claim 1, wherein the XR device is a head-mounted device.

11. The apparatus of claim 1, wherein the at least one processor is configured to:
process the plurality of first images using the first neural network at a first frame rate; and
process the plurality of second images using the second neural network at a second frame rate, wherein the first frame rate is lower than the second frame rate.

12. The apparatus of claim 1, wherein the at least one processor is configured to process the plurality of second images using the second neural network at different intervals based on movable object motion.

13. The apparatus of claim 1, wherein each first image of the plurality of first images has a lower resolution than each second image of the plurality of second images.

14. The apparatus of claim 1, wherein the movable object is a person, animal, or robotic device.

15. The apparatus of claim 1, wherein the first neural network and the second neural network are within the XR device.

16. A method for extended reality (XR), the method comprising:
determining, by a first neural network based on a plurality of first images of a scene, whether a movable object is near an area of the scene, wherein the area includes an XR device worn by a user;
determining, by a second neural network in response to the first neural network determining the movable object is near the area, whether the movable object is within the area based on a plurality of second images of the scene; and
displaying, on a display of the XR device to the user in response to the second neural network determining the movable object is within the area, a visual indication of the movable object within the area of the scene.

17. The method of claim 16, further comprising determining, by the first neural network, whether the movable object is near the area is based on a distance between the movable object and the area being less than a threshold distance.

18. The method of claim 16, wherein determining, by the second neural network, whether the movable object is within the area is further based on determining one or more segmentation masks for the plurality of second images, wherein a segmentation mask of the one or more segmentation masks is associated with the movable object.

19. The method of claim 18, wherein determining, by the second neural network, whether the movable object is within the area is further based on determining a respective depth value for each segmentation mask of the one or more segmentation masks.

20. The method of claim 19, wherein determining, by the second neural network, whether the movable object is within the area is further based on determining a depth value of the respective depth values is not located within a predefined region surrounding the user.
